(19) United States
(12) Patent Application Publication
(10) Pub. No.: US 2024/0413949 A1
(43) Pub. Date: Dec. 12, 2024

(54) DEMODULATION REFERENCE SIGNAL INFORMATION DETERMINING METHOD AND INDICATION METHOD, AND RELATED DEVICE

(71) Applicant: VIVO MOBILE COMMUNICATION CO., LTD., Dongguan (CN)

(72) Inventors: Kaili ZHENG, Dongguan (CN); Hao LIU, Dongguan (CN); Rongrong SUN, Dongguan (CN); Yang SONG, Dongguan (CN); Rakesh TAMRAKAR, Dongguan (CN)

(73) Assignee: VIVO MOBILE COMMUNICATION CO., LTD., Dongguan (CN)

(21) Appl. No.: 18/811,728

(22) Filed: Aug. 21, 2024

Related U.S. Application Data
(63) Continuation of application No. PCT/CN2023/077391, filed on Feb. 21, 2023.

(30) Foreign Application Priority Data
Feb. 24, 2022 (CN) 202210173931.6

(51) Int. Cl. H04L 5/00; H04J 13/00

(52) U.S. Cl. CPC H04L 5/0051; H04J 13/004

(57) ABSTRACT

A demodulation reference signal information determining method, and a terminal are provided. The demodulation reference signal information determining method includes: receiving first Demodulation Reference Signal (DMRS) indication information sent by a network side device. The method further includes determining DMRS information of a target DMRS based on the first DMRS indication information. Ports, belonging to a same Code Division Multiplexing (CDM) group, in the target DMRS are mapped based on a length-4 Frequency Division-Orthogonal Cover Code (FD-OCC) sequence. The DMRS information includes at least one of the following: the quantity of target CDM groups, port information of the target DMRS, or the quantity of front-load symbols. The target CDM group is a CDM group, not occupied by data, in a CDM group corresponding to the target DMRS.

### CROSS-REFERENCE TO RELATED APPLICATIONS

This application is a continuation of International Application No. PCT/CN2023/077391, filed on Feb. 21, 2023, which claims priority to Chinese Patent Application No. 202210173931.6, filed on Feb. 24, 2022. The entire contents of each of the above-referenced applications are expressly incorporated herein by reference

### TECHNICAL FIELD

This application belongs to the field of communication technologies, and specifically relates to a demodulation reference signal information determining method and indication method, and a related device.

### BACKGROUND

In a related technology, a Demodulation Reference Signal (DMRS) of a data channel in a New Radio (NR) system supports a maximum of 12 ports. As a result, a quantity of data flows that can be simultaneously transmitted through the data channel and a quantity of terminals that reuse the data channel based on coordinated scheduling are limited, affecting a transmission capacity of the NR system.

### SUMMARY

Embodiments of this application provide a demodulation reference signal information determining method and indication method, and a related device, which can improve a transmission capability of a communication system.

According to a first aspect, a demodulation reference signal information determining method is provided, including:
a terminal receives first demodulation reference signal DMRS indication information sent by a network side device; and
the terminal determines DMRS information of a target DMRS based on the first DMRS indication information.

Ports, belonging to a same code division multiplexing CDM group, in the target DMRS are mapped based on a length-4 Frequency Division-Orthogonal Cover Code (FD-OCC) sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

According to a second aspect, a demodulation reference signal information indication method is provided, including:
a network side device sends first demodulation reference signal DMRS indication information to a terminal.

The first DMRS indication information is used to determine DMRS information of a target DMRS. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

According to a third aspect, a demodulation reference signal information determining apparatus is provided, including:
a first receiving module, configured to receive first demodulation reference signal DMRS indication information sent by a network side device; and
a determining module, configured to determine DMRS information of a target DMRS based on the first DMRS indication information.

Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

According to a fourth aspect, a demodulation reference signal information indication apparatus is provided, including:
a second sending module, configured to send first demodulation reference signal DMRS indication information to a terminal.

The first DMRS indication information is used to determine DMRS information of a target DMRS. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

According to a fifth aspect, a terminal is provided. The terminal includes a processor and a memory. The memory stores a program or instructions runnable on the processor. When the program or instructions are executed by the processor, the steps of the method according to the first aspect are implemented.

According to a sixth aspect, a terminal is provided, including a processor and a communication interface. The communication interface is configured to receive first demodulation reference signal DMRS indication information sent by a network side device. The processor is configured to determine DMRS information of a target DMRS based on the first DMRS indication information. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

According to a seventh aspect, a network side device is provided. The network side device includes a processor and a memory. The memory stores a program or instructions runnable on the processor. When the program or instructions are executed by the processor, the steps of the method according to the second aspect are implemented.

According to an eighth aspect, a network side device is provided, including a processor and a communication interface. The communication interface is configured to send first demodulation reference signal DMRS indication information to a terminal. The first DMRS indication information is used to determine DMRS information of a target DMRS. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

According to a ninth aspect, a communication system is provided, including a terminal and a network side device. The terminal may be configured to perform the steps of the demodulation reference signal information determining method according to the first aspect. The network side device may be configured to perform the steps of the demodulation reference signal information indication method according to the second aspect.

According to a tenth aspect, a readable storage medium is provided. The readable storage medium stores a program or instructions. When the program or instructions are executed by a processor, the steps of the method according to the first aspect or the steps of the method according to the second aspect are implemented.

According to an eleventh aspect, a chip is provided. The chip includes a processor and a communication interface. The communication interface is coupled to the processor. The processor is configured to run a program or instructions to implement the steps of the method according to the first aspect or the steps of the method according to the second aspect.

According to a twelfth aspect, a computer program/program product is provided. The computer program/program product is stored in a storage medium. The computer program/program product is executed by at least one processor to implement the steps of the method according to the first aspect or the steps of the method according to the second aspect.

According to embodiments of this application, the DMRS information of the target DMRS is determined by using the first DMRS indication information, and the ports, belonging to the same code division multiplexing CDM group, in the target DMRS are mapped based on the length-4 FD-OCC sequence. In this way, a DMRS of a data channel can support more ports. Therefore, according to embodiments of this application, a transmission capacity of the communication system can be improved.

### BRIEF DESCRIPTION OF THE DRAWINGS

FIG. 1 is a diagram of a network structure to which an embodiment of this application is applicable.

FIG. 2 is a schematic flowchart of a demodulation reference signal information determining method according to an embodiment of this application.

FIG. 3 is a schematic flowchart of a demodulation reference signal information indication method according to an embodiment of this application.

FIG. 4 is a diagram of a structure of a demodulation reference signal information determining apparatus according to an embodiment of this application.

FIG. 5 is a diagram of a structure of a demodulation reference signal information indication apparatus according to an embodiment of this application.

FIG. 6 is a diagram of a structure of a communication device according to an embodiment of this application.

FIG. 7 is a diagram of a structure of a terminal according to an embodiment of this application.

FIG. 8 is a diagram of a structure of a network side device according to an embodiment of this application.

### DETAILED DESCRIPTION

The following clearly describes the technical solutions in embodiments of this application with reference to the accompanying drawings in embodiments of this application. It is clear that the described embodiments are some but not all the embodiments of this application. All other embodiments obtained by a person of ordinary skill in the art based on embodiments of this application fall within the protection scope of this application.

The terms “first”, “second”, and the like in this specification and claims of this application are used to distinguish between similar objects instead of describing an order or sequence. It should be understood that the terms used in such a way are interchangeable in appropriate circumstances so that embodiments of this application can be implemented in other orders than the order illustrated or described herein. Moreover, the objects distinguished by “first” and “second” are usually of one type, and the number of objects is not limited. For example, there may be one or more first objects. In addition, “and/or” in the specification and claims represents at least one of connected objects, and the character “/” generally indicates that the associated objects have an “or” relationship.

It is worth noting that a technology described in embodiments of this application is not limited to a Long Term Evolution (LTE)/LTE-Advanced (LTE-A) system, and is also applicable to another wireless communication system, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and another system. The terms “system” and “network” in embodiments of this application are often used interchangeably, and the technology described herein may be used in the above-mentioned systems and radio technologies as well as other systems and radio technologies. The following describes an NR system for example purposes, and uses NR terminology in most of the description below. However, these technologies are also applicable to applications other than NR system applications, such as a 6th Generation (6G) communication system.

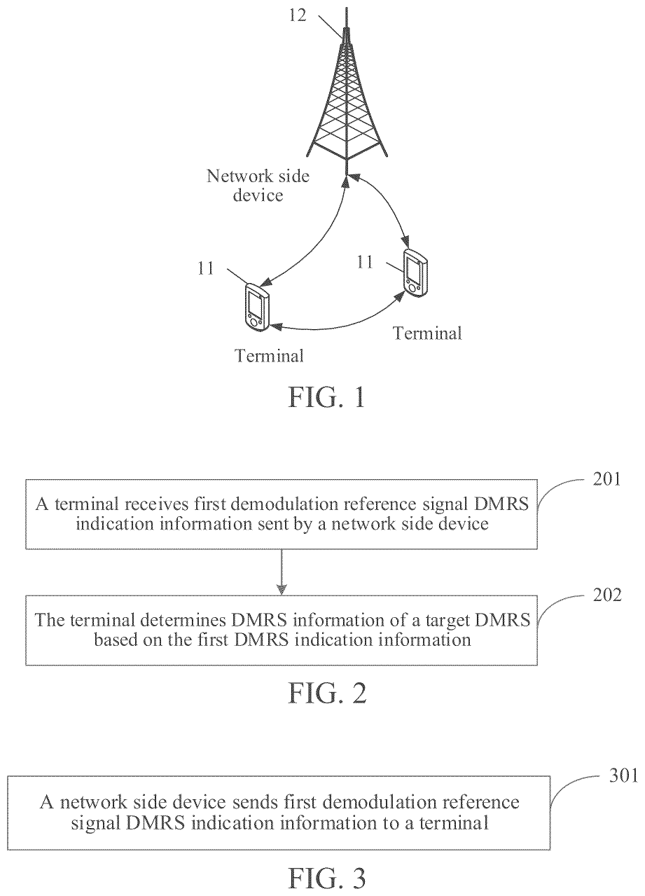

FIG. 1 is a block diagram of a wireless communication system to which an embodiment of this application is applicable. The wireless communication system includes a terminal 11 and a network side device 12. The terminal 11 may be a terminal side device such as a mobile phone, a tablet personal computer, a laptop computer or notebook computer, a Personal Digital Assistant (PDA), a handheld computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or furniture), a game console, a Personal Computer (PC), a teller machine, or a self-service machine. The wearable device includes a smartwatch, a smart band, a smart headset, smart glasses, a smart jewelry (a smart bangle, a smart bracelet, a smart ring, a smart necklace, a smart foot bangle, a smart anklet, or the like), a smart wristband, smart clothing, and the like. It should be noted that a specific type of the terminal 11 is not limited in embodiments of this application. The network side device 12 may also be referred to as a radio access network device, a Radio Access Network (RAN), a radio access network function, or a radio access network unit. The network side device may include a base station, a Wireless Local Area Network (WLAN) access point, a Wi-Fi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or some other appropriate term in the art. As long as the same technical effects are achieved, the base station is not limited to a specific technical term. It should be noted that in embodiments of this application, a base station in the NR system is taken only as an example, and a specific type of the base station is not limited. A core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), and an Application Function (AF). It should be noted that in embodiments of this application, a core network device in the NR system is taken only as an example, and a specific type of the core network device is not limited.

For ease of understanding, the following describes some content in embodiments of this application.

In a current NR system, a DMRS is for channel estimation. A DMRS of a data channel may be classified into a DMRS configuration type 1 and a DMRS configuration type 2 based on a type of the DMRS, and both of the DMRS configuration types support a single-symbol structure and a double-symbol structure. For the DMRS configuration type 1, the single-symbol structure supports a maximum of four ports, and the double-symbol structure supports a maximum of eight ports. For the DMRS configuration type 2, the single-symbol structure supports a maximum of six ports, and the double-symbol structure supports a maximum of twelve ports. In addition, the DMRS configuration type 1 supports two Code Division Multiplexing (CDM) groups, and the DMRS configuration type 2 supports three CDM groups.

In the NR system, the DMRS configuration type 1 of the data channel supports a maximum of eight ports, and the DMRS configuration type 2 supports a maximum of twelve ports. As a result, a quantity of data flows that can be simultaneously transmitted through the data channel and a quantity of terminals that reuse the data channel based on coordinated scheduling are both limited. In view of this, this application proposes a demodulation reference signal information determining method.

The following describes in detail the demodulation reference signal information determining method provided in embodiments of this application through some embodiments and application scenarios thereof with reference to the accompanying drawings.

Refer to FIG. 1. An embodiment of this application provides a demodulation reference signal information determining method, including the following steps.

Step 201: A terminal receives first demodulation reference signal DMRS indication information sent by a network side device.

Step 202: The terminal determines DMRS information of a target DMRS based on the first DMRS indication information.

Ports, belonging to a same code division multiplexing CDM group, in the target DMRS are mapped based on a length-4 Frequency Division-Orthogonal Cover Code (FD-OCC) sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

In this embodiment of this application, because the ports, belonging to the same code division multiplexing CDM group, in the target DMRS are mapped based on the length-4 FD-OCC sequence, in a case in which the target DMRS is a DMRS of a first configuration type, when the quantity of front-load symbols corresponding to the target DMRS is 1, the target DMRS supports a maximum of eight ports, or when the quantity of front-load symbols corresponding to the target DMRS is 2, the target DMRS supports a maximum of sixteen ports; or in a case in which the target DMRS is a DMRS of a second configuration type, when the quantity of front-load symbols corresponding to the target DMRS is 1, the target DMRS supports a maximum of twelve ports, or when the quantity of front-load symbols corresponding to the target DMRS is 2, the target DMRS supports a maximum of twenty-four ports (the port may be referred to as a DMRS port). Therefore, a transmission capacity of a communication system can be improved.

It should be understood that the quantity of front-load symbols may be 1 or 2. When the quantity of front-load symbols is 1, the DMRS is correspondingly of a single-symbol structure. When the quantity of front-load symbols is 2, the DMRS is correspondingly of a double-symbol structure.

According to this embodiment of this application, the DMRS information of the target DMRS is determined by using the first DMRS indication information, and the ports, belonging to the same code division multiplexing CDM group, in the target DMRS are mapped based on the length-4 FD-OCC sequence. In this way, a DMRS of a data channel can support more ports. Therefore, according to this embodiment of this application, the transmission capacity of the communication system can be improved.

It should be noted that in this embodiment of this application, the first DMRS indication information may use X bits for indication. The network side device and the terminal device may predetermine a DMRS indication table by default. Under each DMRS configuration type, different indication tables may be used based on a codeword enable status and a maximum symbol length of the DMRS. When DMRS information in different indication tables is indicated, X may be valued to be different. For example, when the indication table includes four rows of DMRS information, X may be valued to 2. When the indication table includes eight rows of DMRS information, X may be valued to 3. When the indication table includes sixteen rows of DMRS information, X may be valued to 4. When the indication table includes thirty-two rows of DMRS information, X may be valued to 5. When the indication table includes sixty-four rows of DMRS information, X may be valued to 6. When the indication table includes one hundred and twenty-eight rows of DMRS information, X may be valued to 7. The first DMRS indication information may be downlink control information (Downlink Control Information, DCI) or information carried through DCI.

In some embodiments, the terminal may determine, based on a quantity of bits of the first DMRS indication information, an indication table for determining the DMRS information, or determine, based on Radio Resource Control (RRC) signaling configured by the network side device, an indication table for determining the DMRS information.

It should be understood that in this embodiment of this application, an index value of each of a first port to a twenty-fourth port may be set based on an actual requirement. For example, the first port may be a 1st port, or may be any intermediate port.

In some embodiments, the first port, a second port, a third port, a fourth port, a fifth port, a sixth port, a seventh port, and an eighth port may respectively correspond to a port 0, a port 1, a port 2, a port 3, a port 4, a port 5, a port 6, and a port 7, or respectively correspond to a port 0, a port 1, a port 8, a port 9, a port 2, a port 3, a port 10, and a port 11. Respectively corresponding means corresponding one to one in sequence. For example, the first correspondence manner may be understood as follows: the first port corresponds to the port 0, the second port corresponds to the port 1, the third port corresponds to the port 2, the fourth port corresponds to the port 3, the fifth port corresponds to the port 4, the sixth port corresponds to the port 5, the seventh port corresponds to the port 6, and the eighth port corresponds to the port 7.

In some embodiments, the first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, and a sixteenth port may respectively correspond to a port 0, a port 1, a port 2, a port 3, a port 4, a port 5, a port 6, a port 7, a port 8, a port 9, a port 10, a port 11, a port 12, a port 13, a port 14, and a port 15, or respectively correspond to a port 0, a port 1, a port 4, a port 5, a port 2, a port 3, a port 6, a port 7, a port 8, a port 9, a port 12, a port 13, a port 10, a port 11, a port 14, and a port 15.

In some embodiments, the first port, a second port, a third port, a fourth port, a fifth port, a sixth port, a seventh port, an eighth port, a ninth port, a tenth port, an eleventh port, and a twelfth port respectively correspond to a port 0, a port 1, a port 2, a port 3, a port 4, a port 5, a port 6, a port 7, a port 8, a port 9, a port 10, and a port 11, or respectively correspond to a port 0, a port 1, a port 12, a port 13, a port 2, a port 3, a port 8, a port 9, a port 4, a port 5, a port 16, and a port 17.

In some embodiments, the first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, a sixteenth port, a seventeenth port, an eighteenth port, a nineteenth port, a twentieth port, a twenty-first port, a twenty-second port, a twenty-third port, and the twenty-fourth port respectively correspond to a port 0, a port 1, a port 2, a port 3, a port 4, a port 5, a port 6, a port 7, a port 8, a port 9, a port 10, a port 11, a port 12, a port 13, a port 14, a port 15, a port 16, a port 17, a port 18, a port 19, a port 20, a port 21, a port 22, and a port 23, or respectively correspond to a port 0, a port 1, a port 6, a port 7, a port 2, a port 3, a port 8, a port 9, a port 4, a port 5, a port 10, a port 11, a port 12, a port 13, a port 18, a port 19, a port 14, a port 15, a port 20, a port 21, a port 16, a port 17, a port 22, and a port 23.

In other words, an index of a port of the DMRS is numbered from 0. An example in which an n-th port is a port n−1 is used for description in each of the following embodiments, where n is a positive integer less than or equal to 24.

For better understanding, the following describes, in detail for different maximum quantities of ports supported by the target DMRS and different configuration types of the DMRS, content of determining the DMRS information of the target DMRS based on the first DMRS indication information.

For example, in some embodiments, it is assumed that a port supported by the target DMRS includes the first port, the second port, the third port, the fourth port, the fifth port, the sixth port, the seventh port, and the eighth port. The first port, the second port, the third port, and the fourth port belong to a first CDM group. The fifth port, the sixth port, the seventh port, and the eighth port belong to a second CDM group.

In this embodiment of this application, in a case in which the target DMRS is the DMRS of the first configuration type, and a maximum symbol length of the target DMRS is 1, the DMRS information includes first DMRS information or second DMRS information. The first configuration type may be understood as a DMRS configuration type associated with a DMRS configuration type 1. For example, the first configuration type may be the DMRS configuration type 1 or an enhanced DMRS configuration type 1.

The first DMRS information includes any one of the following:
the quantity of target CDM groups is 1, and the port information includes any one of the first port, the second port, the third port, and the fourth port;
the quantity of target CDM groups is 1, and the port information includes the first port and the second port, or includes the third port and the fourth port;
the quantity of target CDM groups is 1, and the port information includes the first port, the second port, and the third port;
the quantity of target CDM groups is 1, and the port information includes the first port, the second port, the third port, and the fourth port;
the quantity of target CDM groups is 2, and the port information includes any one of the first port, the second port, the third port, the fourth port, the fifth port, the sixth port, the seventh port, and the eighth port;
the quantity of target CDM groups is 2, and the port information includes the first port and the second port, includes the third port and the fourth port, includes the fifth port and the sixth port, includes the seventh port and the eighth port, or includes the first port and the fifth port;
the quantity of target CDM groups is 2, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port; and
the quantity of target CDM groups is 2, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port.

The first DMRS information includes: The quantity of target CDM groups is 2, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port.

In some embodiments, in a case in which a single codeword is enabled, when a type of the target DMRS is the first configuration type, and the maximum symbol length (maxlength) of the target DMRS is 1, the DMRS information of the target DMRS may be determined based on the first DMRS indication information. The DMRS information may include the first DMRS information. In this embodiment of this application, the DMRS information may be determined based on a DMRS indication table (that is, Table 1).

TABLE 1

| | Quantity | Port | | Quantity | Port |
|---|---|---|---|---|---|
| Serial | of target | infor- | Serial | of target | infor- |
| number | CDM groups | mation | number | CDM groups | mation |
| 0 | 1 | 0 | 14 | 2 | 6 |
| 1 | 1 | 1 | 15 | 2 | 7 |
| 2 | 1 | 2 | 16 | 2 | 0 and 1 |
| 3 | 1 | 3 | 17 | 2 | 2 and 3 |
| 4 | 1 | 0 and 1 | 18 | 2 | 4 and 5 |
| 5 | 1 | 2 and 3 | 19 | 2 | 6 and 7 |
| 6 | 1 | 0 to 2 | 20 | 2 | 0 and 4 |
| 7 | 1 | 0 to 3 | 21 | 2 | 0 to 2 |
| 8 | 2 | 0 | 22 | 2 | 4 to 6 |
| 9 | 2 | 1 | 23 | 2 | 0, 1, and 4 |
| 10 | 2 | 2 | 24 | 2 | 0, 4, and 5 |
| 11 | 2 | 3 | 25 | 2 | 0 to 3 |
| 12 | 2 | 4 | 26 | 2 | 4 to 7 |
| 13 | 2 | 5 | 27 | 2 | 0, 4, 5, and 6 |
| 14 | 2 | 6 | 28 | 2 | 0, 1, 2, and 4 |
| 15 | 2 | 7 | 29 | 2 | 0, 1, 4, and 5 |
| 16 | 2 | 0 and 1 | 30 to 31 | Reserved | Reserved |

For Table 1, the first DMRS indication information may use five bits for indication. For example, a corresponding serial number value (for example, a value of value) may be indicated by the five bits to indicate the DMRS information of the target DMRS.

In some embodiments, in a case in which double codewords are enabled, when a type of the target DMRS is the first configuration type, and the maximum symbol length of the target DMRS is 1, the DMRS information of the target DMRS may be determined based on the first DMRS indication information. The DMRS information may include the second DMRS information. In this embodiment of this application, the DMRS information may be determined based on a DMRS indication table (that is, Table 2).

TABLE 2

| | Quantity | |
|---|---|---|
| Serial | of target | Port |
| number | CDM groups | information |
| 0 | 2 | 0, 1, 2, 4, and 5 |
| 1 | 2 | 0, 1, 2, 4, 5, and 6 |
| 2 | 2 | 0, 1, 2, 3, 4, 5, and 6 |
| 3 | 2 | 0, 1, 2, 3, 4, 5, 6, and 7 |

For Table 2, the first DMRS indication information may use two bits for indication.

For example, in some embodiments, it is assumed that a port supported by the target DMRS includes the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, and the sixteenth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group.

In this embodiment of this application, in a case in which the target DMRS is the DMRS of the first configuration type, and a maximum symbol length of the target DMRS is 2, the DMRS information includes third DMRS information or fourth DMRS information.

The third DMRS information includes any one of the following:
the quantity of target CDM groups is 1, the quantity of front-load symbols is 1, and the port information includes the first port and the second port, or includes the third port and the fourth port;
the quantity of target CDM groups is 1, the quantity of front-load symbols is 1, and the port information includes the first port, the second port, and the third port;
the quantity of target CDM groups is 1, the quantity of front-load symbols is 1, and the port information includes the first port, the second port, the third port, and the fourth port; the quantity of target CDM groups is 2, the quantity of front-load symbols is 1, and the port information includes any one of the first port, the second port, the third port, the fourth port, the fifth port, the sixth port, the seventh port, and the eighth port;
the quantity of target CDM groups is 2, the quantity of front-load symbols is 1, and the port information includes the first port and the second port, includes the third port and the fourth port, includes the fifth port and the sixth port, includes the seventh port and the eighth port, or includes the first port and the fifth port;
the quantity of target CDM groups is 2, the quantity of front-load symbols is 1, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port;
the quantity of target CDM groups is 2, the quantity of front-load symbols is 1, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port;
the quantity of target CDM groups is 2, the quantity of front-load symbols is 2, and the port information includes any one of the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, and the sixteenth port;
the quantity of target CDM groups is 2, the quantity of front-load symbols is 2, and the port information includes the first port and the second port, includes the third port and the fourth port, includes the fifth port and the sixth port, includes the seventh port and the eighth port, includes the ninth port and the tenth port, includes the eleventh port and the twelfth port, includes the thirteenth port and the fourteenth port, includes the fifteenth port and the sixteenth port, includes the first port and the ninth port, or includes the fifth port and the thirteenth port;
the quantity of target CDM groups is 2, the quantity of front-load symbols is 2, and the port information includes the first port, the second port, and the third port, includes the fifth port, the sixth port, and the seventh port, includes the first port, the second port, and the ninth port, or includes the fifth port, the sixth port, and the thirteenth port; and the quantity of target CDM groups is 2, the quantity of front-load symbols is 2, and the port information includes the first port, the second port, the third port, and the fourth port, the fifth port, the sixth port, the seventh port, and the eighth port, includes the first port, the second port, the ninth port, and the tenth port, or includes the fifth port, the sixth port, the thirteenth port, and the fourteenth port.

The fourth DMRS information includes any one of the following:
the quantity of target CDM groups is 2, the quantity of front-load symbols is 1, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port;
the quantity of target CDM groups is 1 or 2, the quantity of front-load symbols is 2, and the port information includes the first port, the second port, the third port, the fourth port, and the ninth port, includes the first port, the second port, the third port, the fourth port, the ninth port, and the tenth port, includes the first port, the second port, the third port, the fourth port, the ninth port, the tenth port, and the eleventh port, or includes the first port, the second port, the third port, the fourth port, the ninth port, the tenth port, the eleventh port, and the twelfth port; and
the quantity of target CDM groups is 2, the quantity of front-load symbols is 2, and the port information includes the fifth port, the sixth port, the seventh port, the eighth port, and the thirteenth port, includes the fifth port, the sixth port, the seventh port, the eighth port, the thirteenth port, and the fourteenth port, includes the fifth port, the sixth port, the seventh port, the eighth port, the thirteenth port, the fourteenth port, and the fifteenth port, or includes the fifth port, the sixth port, the seventh port, the eighth port, the thirteenth port, the fourteenth port, the fifteenth port, and the sixteenth port.

In some embodiments, in a case in which a single codeword is enabled, when a type of the target DMRS is the first configuration type, and the maximum symbol length of the target DMRS is 2, the DMRS information of the target DMRS may be determined based on the first DMRS indication information. The DMRS information may include the third DMRS information. In this embodiment of this application, the DMRS information may be determined based on a DMRS indication table (that is, Table 3).

TABLE 3

| | Quantity | | Quantity |
|---|---|---|---|
| Serial | of target | Port | of front- |
| number | CDM groups | information | load symbols |
| 0 | 1 | 0 | 1 |
| 1 | 1 | 1 | 1 |
| 2 | 1 | 2 | 1 |
| 3 | 1 | 3 | 1 |
| 4 | 1 | 0 and 1 | 1 |
| 5 | 1 | 2 and 3 | 1 |
| 6 | 1 | 0 to 2 | 1 |
| 7 | 1 | 0 to 3 | 1 |
| 8 | 2 | 0 | 1 |
| 9 | 2 | 1 | 1 |
| 10 | 2 | 2 | 1 |
| 11 | 2 | 3 | 1 |
| 12 | 2 | 4 | 1 |
| 13 | 2 | 5 | 1 |
| 14 | 2 | 6 | 1 |
| 15 | 2 | 7 | 1 |
| 16 | 2 | 0 and 1 | 1 |
| 17 | 2 | 2 and 3 | 1 |
| 18 | 2 | 4 and 5 | 1 |
| 19 | 2 | 6 and 7 | 1 |
| 20 | 2 | 0 and 4 | 1 |
| 21 | 2 | 0 to 2 | 1 |
| 22 | 2 | 4 to 6 | 1 |
| 23 | 2 | 0, 1, and 4 | 1 |
| 24 | 2 | 0, 4, and 5 | 1 |
| 25 | 2 | 0 to 3 | 1 |
| 26 | 2 | 467 | 1 |
| 27 | 2 | 0, 4, 5, and 6 | 1 |
| 28 | 2 | 0, 1, 2, and 4 | 1 |
| 29 | 2 | 0, 1, 4, and 5 | 1 |
| 30 | 2 | 0 | 2 |
| 31 | 2 | 1 | 2 |
| 32 | 2 | 2 | 2 |
| 33 | 2 | 3 | 2 |
| 34 | 2 | 4 | 2 |
| 35 | 2 | 5 | 2 |
| 36 | 2 | 6 | 2 |
| 37 | 2 | 7 | 2 |
| 38 | 2 | 8 | 2 |
| 39 | 2 | 9 | 2 |
| 40 | 2 | 10 | 2 |
| 41 | 2 | 11 | 2 |
| 42 | 2 | 12 | 2 |
| 43 | 2 | 13 | 2 |
| 44 | 2 | 14 | 2 |
| 45 | 2 | 15 | 2 |
| 46 | 2 | 0 and 1 | 2 |
| 47 | 2 | 2 and 3 | 2 |
| 48 | 2 | 4 and 5 | 2 |
| 49 | 2 | 6 and 7 | 2 |
| 50 | 2 | 8 and 9 | 2 |
| 51 | 2 | 10 and 11 | 2 |
| 52 | 2 | 12 and 13 | 2 |
| 53 | 2 | 14 and 15 | 2 |
| 54 | 2 | 0 and 8 | 2 |
| 55 | 2 | 4 and 12 | 2 |
| 56 | 2 | 0 to 2 | 2 |
| 57 | 2 | 4 to 6 | 2 |
| 58 | 2 | 0, 1, and 8 | 2 |
| 59 | 2 | 4, 5, and 12 | 2 |
| 60 | 2 | 0 to 3 | 2 |
| 61 | 2 | 4 to 7 | 2 |
| 62 | 2 | 0, 1, 8, and 9 | 2 |
| 63 | 2 | 4, 5, 12, and 13 | 2 |

For Table 3, the first DMRS indication information may use six bits for indication. In some embodiments, in a case in which double codewords are enabled, when a type of the target DMRS is the first configuration type, and the maximum symbol length of the target DMRS is 2, the DMRS information of the target DMRS may be determined based on the first DMRS indication information. The DMRS information may include the fourth DMRS information. In this embodiment of this application, the DMRS information may be determined based on a DMRS indication table (that is, Table 4).

TABLE 4

| | Quantity | | Quantity |
|---|---|---|---|
| Serial | of target | Port | of front- |
| number | CDM groups | information | load symbols |
| 0 | 2 | 0, 1, 2, 4, and 5 | 1 |
| 1 | 2 | 0, 1, 2, 4, 5, and 6 | 1 |
| 2 | 2 | 0, 1, 2, 3, 4, 5, and 6 | 1 |
| 3 | 2 | 0, 1, 2, 3, 4, 5, 6, and 7 | 1 |
| 4 | 1 | 0, 1, 2, 3, and 8 | 2 |
| 5 | 1 | 0, 1, 2, 3, 8, and 9 | 2 |
| 6 | 1 | 0, 1, 2, 3, 8, 9, and 10 | 2 |
| 7 | 1 | 0, 1, 2, 3, 8, 9, 10, and 11 | 2 |
| 8 | 2 | 0, 1, 2, 3, and 8 | 2 |
| 9 | 2 | 4, 5, 6, 7, and 12 | 2 |
| 10 | 2 | 0, 1, 2, 3, 8, and 9 | 2 |
| 11 | 2 | 4, 5, 6, 7, 12, and 13 | 2 |
| 12 | 2 | 0, 1, 2, 3, 8, 9, and 10 | 2 |
| 13 | 2 | 4, 5, 6, 7, 12, 13, and 14 | 2 |
| 14 | 2 | 0, 1, 2, 3, 8, 9, 10, and 11 | 2 |
| 15 | 2 | 4, 5, 6, 7, 12, 13, 14, and 15 | 2 |

For Table 4, the first DMRS indication information may use four bits for indication.

For example, in some embodiments, it is assumed that a port supported by the target DMRS includes the first port, the second port, the third port, the fourth port, the fifth port, the sixth port, the seventh port, the eighth port, the ninth port, the tenth port, the eleventh port, and the twelfth port. The first port, the second port, the third port, and the fourth port belong to a first CDM group. The fifth port, the sixth port, the seventh port, and the eighth port belong to a second CDM group. The ninth port, the tenth port, the eleventh port, and the twelfth port belong to a third CDM group.

In this embodiment of this application, in a case in which the target DMRS is the DMRS of the second configuration type, and a maximum symbol length of the target DMRS is 1, the DMRS information includes fifth DMRS information or sixth DMRS information. The second configuration type may be understood as a DMRS configuration type associated with a DMRS configuration type 2. For example, the first configuration type may be the DMRS configuration type 2 or an enhanced DMRS configuration type 2.

The fifth DMRS information includes any one of the following:
the quantity of target CDM groups is 1, and the port information includes any one of the first port, the second port, the third port, and the fourth port;
the quantity of target CDM groups is 1, and the port information includes the first port and the second port, or includes the third port and the fourth port;
the quantity of target CDM groups is 1, and the port information includes the first port, the second port, and the third port;
the quantity of target CDM groups is 1, and the port information includes the first port, the second port, the third port, and the fourth port;
the quantity of target CDM groups is 2, and the port information includes any one of the first port, the second port, the third port, the fourth port, the fifth port, the sixth port, the seventh port, and the eighth port;
the quantity of target CDM groups is 2, and the port information includes the first port and the second port, includes the third port and the fourth port, includes the fifth port and the sixth port, includes the seventh port and the eighth port, or includes the first port and the fifth port; the quantity of target CDM groups is 2, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port;
the quantity of target CDM groups is 2, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port;
the quantity of target CDM groups is 3, and the port information includes any one of the first port, the second port, the third port, the fourth port, the fifth port, the sixth port, the seventh port, the eighth port, the ninth port, the tenth port, the eleventh port, and the twelfth port;
the quantity of target CDM groups is 2, and the port information includes the first port and the second port, includes the third port and the fourth port, includes the fifth port and the sixth port, includes the seventh port and the eighth port, includes the ninth port and the tenth port, or includes the eleventh port and the twelfth port;
the quantity of target CDM groups is 3, and the port information includes the first port, the second port, and the third port, includes the fifth port, the sixth port, and the seventh port, or includes the ninth port, the tenth port, and the eleventh port; and
the quantity of target CDM groups is 3, and the port information includes the first port, the second port, the third port, and the fourth port, includes the fifth port, the sixth port, the seventh port, and the eighth port, or includes the ninth port, the tenth port, the eleventh port, and the twelfth port.

The sixth DMRS information includes: The quantity of target CDM groups is 2 or 3, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port.

In some embodiments, in a case in which a single codeword is enabled, when a type of the target DMRS is the second configuration type, and the maximum symbol length of the target DMRS is 1, the DMRS information of the target DMRS may be determined based on the first DMRS indication information. The DMRS information may include the first DMRS information. In this embodiment of this application, the DMRS information may be determined based on a DMRS indication table (that is, Table 5).

TABLE 5

| | Quantity | Port | | Quantity | Port |
|---|---|---|---|---|---|
| Serial | of target | infor- | Serial | of target | infor- |
| number | CDM groups | mation | number | CDM groups | mation |
| 0 | 1 | 0 | 27 | 2 | 0, 4, 5, |
| | | | | | and 6 |
| 1 | 1 | 1 | 28 | 2 | 0, 1, 2, |
| | | | | | and 4 |
| 2 | 1 | 2 | 29 | 2 | 0, 1, 4, |
| | | | | | and 5 |
| 3 | 1 | 3 | 30 | 3 | 0 |
| 4 | 1 | 0 and 1 | 31 | 3 | 1 |
| 5 | 1 | 2 and 3 | 32 | 3 | 2 |
| 6 | 1 | 0 to 2 | 33 | 3 | 3 |
| 7 | 1 | 0 to 3 | 34 | 3 | 4 |
| 8 | 2 | 0 | 35 | 3 | 5 |
| 9 | 2 | 1 | 36 | 3 | 6 |
| 10 | 2 | 2 | 37 | 3 | 7 |
| 11 | 2 | 3 | 38 | 3 | 8 |
| 12 | 2 | 4 | 39 | 3 | 9 |
| 13 | 2 | 5 | 40 | 3 | 10 |
| 14 | 2 | 6 | 41 | 3 | 11 |
| 15 | 2 | 7 | 42 | 3 | 0 and 1 |
| 16 | 2 | 0 and 1 | 43 | 3 | 2 and 3 |
| 17 | 2 | 2 and 3 | 44 | 3 | 4 and 5 |
| 18 | 2 | 4 and 5 | 45 | 3 | 6 and 7 |
| 19 | 2 | 6 and 7 | 46 | 3 | 8 and 9 |
| 20 | 2 | 0 and 4 | 47 | 3 | 10 and 11 |
| 21 | 2 | 0 to 2 | 48 | 3 | 0 to 2 |
| 22 | 2 | 4 to 6 | 49 | 3 | 4 to 6 |
| 23 | 2 | 0, 1, and 4 | 50 | 3 | 8 to 10 |
| 24 | 2 | 0, 4, and 5 | 51 | 3 | 0 to 3 |
| 25 | 2 | 0 to 3 | 52 | 3 | 4 to 7 |
| 26 | 2 | 4 to 7 | 53 | 3 | 8 to 11 |
| 27 | 2 | 0, 4, 5, | 54 to 63 | Reserved | Reserved |
| | | and 6 | | | |
| 28 | 2 | 0, 1, 2, | | | |
| | | and 4 | | | |

In some embodiments, in a case in which double codewords are enabled, when a type of the target DMRS is the second configuration type, and the maximum symbol length of the target DMRS is 1, the DMRS information of the target DMRS may be determined based on the first DMRS indication information. The DMRS information may include the first DMRS information. In this embodiment of this application, the DMRS information may be determined based on a DMRS indication table (that is, Table 6 or Table 7).

TABLE 6

| | Quantity | |
|---|---|---|
| Serial | of target | Port |
| number | CDM groups | information |
| 0 | 2 | 0, 1, 2, 4, and 5 |
| 1 | 2 | 0, 1, 2, 4, 5, and 6 |
| 2 | 2 | 0, 1, 2, 3, 4, 5, and 6 |
| 3 | 2 | 0, 1, 2, 3, 4, 5, 6, and 7 |
| 4 | 3 | 0, 1, 2, 4, and 5 |
| 5 | 3 | 0, 1, 2, 4, 5, and 6 |
| 6 | 3 | 0, 1, 2, 3, 4, 5, and 6 |
| 7 | 3 | 0, 1, 2, 3, 4, 5, 6, and 7 |

For Table 6, the first DMRS indication information may use three bits for indication.

TABLE 7

| | Quantity | |
|---|---|---|
| Serial | of target | Port |
| number | CDM groups | information |
| 0 | 2 | 0, 1, 2, 4, and 5 |
| 1 | 2 | 0, 1, 2, 4, 5, and 6 |
| 2 | 2 | 0, 1, 2, 3, 4, 5, and 6 |
| 3 | 2 | 0, 1, 2, 3, 4, 5, 6, and 7 |

For Table 7, the first DMRS indication information may use two bits for indication.

For example, in some embodiments, it is assumed that a port supported by the target DMRS includes the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, the sixteenth port, the seventeenth port, the eighteenth port, the nineteenth port, the twentieth port, the twenty-first port, the twenty-second port, the twenty-third port, and the twenty-fourth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group. The seventeenth port, the eighteenth port, the nineteenth port, the twentieth port, the twenty-first port, the twenty-second port, the twenty-third port, and the twenty-fourth port belong to a third CDM group.

In this embodiment of this application, in a case in which the target DMRS is the DMRS of the second configuration type, and a maximum symbol length of the target DMRS is 2, the DMRS information includes seventh DMRS information or eighth DMRS information.

The seventh DMRS information includes any one of the following:
the quantity of target CDM groups is 1, the quantity of front-load symbols is 1, and the port information includes any one of the first port, the second port, the third port, and the fourth port;
the quantity of target CDM groups is 1, the quantity of front-load symbols is 1, and the port information includes the first port and the second port, or includes the third port and the fourth port;
the quantity of target CDM groups is 1, the quantity of front-load symbols is 1, and the port information includes the first port, the second port, and the third port;
the quantity of target CDM groups is 1, the quantity of front-load symbols is 1, and the port information includes the first port, the second port, the third port, and the fourth port;
the quantity of target CDM groups is 2, the quantity of front-load symbols is 1, and the port information includes any one of the first port, the second port, the third port, the fourth port, the fifth port, the sixth port, the seventh port, and the eighth port;
the quantity of target CDM groups is 2, the quantity of front-load symbols is 1, and the port information includes the first port and the second port, includes the third port and the fourth port, includes the fifth port and the sixth port, includes the seventh port and the eighth port, or includes the first port and the fifth port;
the quantity of target CDM groups is 2, the quantity of front-load symbols is 1, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port;
the quantity of target CDM groups is 2, the quantity of front-load symbols is 1, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port;
the quantity of target CDM groups is 3, the quantity of front-load symbols is 1, and the port information includes any one of the first port, the second port, the third port, the fourth port, the fifth port, the sixth port, the seventh port, the eighth port, the ninth port, the tenth port, the eleventh port, and the twelfth port;
the quantity of target CDM groups is 3, the quantity of front-load symbols is 1, and the port information includes the first port and the second port, includes the third port and the fourth port, includes the fifth port and the sixth port, includes the seventh port and the eighth port, includes the ninth port and the tenth port, or includes the eleventh port and the twelfth port;
the quantity of target CDM groups is 3, the quantity of front-load symbols is 1, and the port information includes the first port, the second port, and the third port, includes the fifth port, the sixth port, and the seventh port, or includes the ninth port, the tenth port, and the eleventh port;
the quantity of target CDM groups is 3, the quantity of front-load symbols is 1, and the port information includes the first port, the second port, the third port, and the fourth port, includes the fifth port, the sixth port, the seventh port, and the eighth port, or includes the ninth port, the tenth port, the eleventh port, and the twelfth port;
the quantity of target CDM groups is 3, the quantity of front-load symbols is 2, and the port information includes any one of the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, the sixteenth port, the seventeenth port, the eighteenth port, the nineteenth port, the twentieth port, the twenty-first port, the twenty-second port, the twenty-third port, and the twenty-fourth port;
the quantity of target CDM groups is 3, the quantity of front-load symbols is 2, and the port information includes the first port and the second port, includes the third port and the fourth port, includes the fifth port and the sixth port, includes the seventh port and the eighth port, includes the ninth port and the tenth port, includes the eleventh port and the twelfth port, includes the thirteenth port and the fourteenth port, includes the fifteenth port and the sixteenth port, includes the seventeenth port and the eighteenth port, includes the nineteenth port and the twentieth port, includes the twenty-first port and the twenty-second port, or includes the twenty-third port and the twenty-fourth port;
the quantity of target CDM groups is 3, the quantity of front-load symbols is 2, and the port information includes the first port, the second port, and the third port, includes the fifth port, the sixth port, and the seventh port, or includes the ninth port, the tenth port, and the eleventh port;
the quantity of target CDM groups is 3, the quantity of front-load symbols is 2, and the port information includes the first port, the second port, the third port, and the fourth port, includes the fifth port, the sixth port, the seventh port, and the eighth port, or includes the ninth port, the tenth port, the eleventh port, and the twelfth port;
the quantity of target CDM groups is 1, the quantity of front-load symbols is 2, and the port information includes any one of the first port, the second port, the third port, the fourth port, the thirteenth port, the fourteenth port, the fifteenth port, and the sixteenth port;
the quantity of target CDM groups is 1, the quantity of front-load symbols is 2, and the port information includes the first port and the second port, includes the third port and the fourth port, includes the thirteenth port and the fourteenth port, or includes the fifteenth port and the sixteenth port;
the quantity of target CDM groups is 1, the quantity of front-load symbols is 2, and the port information includes the first port, the second port, and the third port, or includes the thirteenth port, the fourteenth port, and the fifteenth port;
the quantity of target CDM groups is 1, the quantity of front-load symbols is 2, and the port information includes the first port, the second port, the third port, and the fourth port, or includes the thirteenth port, the fourteenth port, the fifteenth port, and the sixteenth port;
the quantity of target CDM groups is 2, the quantity of front-load symbols is 2, and the port information includes the first port and the second port, includes the third port and the fourth port, includes the fifth port and the sixth port, includes the seventh port and the eighth port, includes the thirteenth port and the fourteenth port, includes the fifteenth port and the sixteenth port, includes the seventeenth port and the eighteenth port, or includes the nineteenth port and the twentieth port;
the quantity of target CDM groups is 2, the quantity of front-load symbols is 2, and the port information includes the first port, the second port, and the third port, or includes the fifth port, the sixth port, and the seventh port; and
the quantity of target CDM groups is 2, the quantity of front-load symbols is 2, and the port information includes the first port, the second port, the third port, and the fourth port, or includes the fifth port, the sixth port, the seventh port, and the eighth port.

The eighth DMRS information includes any one of the following:
the quantity of target CDM groups is 2, the quantity of front-load symbols is 1, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port;
the quantity of target CDM groups is 1 or 2, the quantity of front-load symbols is 2, and the port information includes the first port, the second port, the third port, the fourth port, and the thirteenth port, includes the first port, the second port, the third port, the fourth port, the thirteenth port, and the fourteenth port, includes the first port, the second port, the third port, the fourth port, the thirteenth port, the fourteenth port, and the fifteenth port, or includes the first port, the second port, the third port, the fourth port, the thirteenth port, the fourteenth port, the fifteenth port, and the sixteenth port; and
the quantity of target CDM groups is 2, the quantity of front-load symbols is 2, and the port information includes the fifth port, the sixth port, the seventh port, the eighth port, and the seventeenth port, includes the fifth port, the sixth port, the seventh port, the eighth port, the seventeenth port, and the eighteenth port, includes the fifth port, the sixth port, the seventh port, the eighth port, the seventeenth port, the eighteenth port, and the nineteenth port, or includes the fifth port, the sixth port, the seventh port, the eighth port, the seventeenth port, the eighteenth port, the nineteenth port, and the twentieth port.

In some embodiments, in a case in which a single codeword is enabled, when a type of the target DMRS is the second configuration type, and the maximum symbol length of the target DMRS is 2, the DMRS information of the target DMRS may be determined based on the first DMRS indication information. The DMRS information may include the first DMRS information. In this embodiment of this application, the DMRS information may be determined based on a DMRS indication table (that is, Table 8).

TABLE 8

| | Quantity | | Quantity |
|---|---|---|---|
| Serial | of target | Port | of front- |
| number | CDM groups | information | load symbols |
| 0 | 1 | 0 | 1 |
| 1 | 1 | 1 | 1 |
| 2 | 1 | 2 | 1 |
| 3 | 1 | 3 | 1 |
| 4 | 1 | 0 and 1 | 1 |
| 5 | 1 | 2 and 3 | 1 |
| 6 | 1 | 0 to 2 | 1 |
| 7 | 1 | 0 to 3 | 1 |
| 8 | 2 | 0 | 1 |
| 9 | 2 | 1 | 1 |
| 10 | 2 | 2 | 1 |
| 11 | 2 | 3 | 1 |
| 12 | 2 | 4 | 1 |
| 13 | 2 | 5 | 1 |
| 14 | 2 | 6 | 1 |
| 15 | 2 | 7 | 1 |
| 16 | 2 | 0 and 1 | 1 |
| 17 | 2 | 2 and 3 | 1 |
| 18 | 2 | 4 and 5 | 1 |
| 19 | 2 | 6 and 7 | 1 |
| 20 | 2 | 0 and 4 | 1 |
| 21 | 2 | 0 to 2 | 1 |
| 22 | 2 | 4 to 6 | 1 |
| 23 | 2 | 0, 1, and 4 | 1 |
| 24 | 2 | 0, 4, and 5 | 1 |
| 25 | 2 | 0 to 3 | 1 |
| 26 | 2 | 4 to 7 | 1 |
| 27 | 2 | 0, 4, 5, and 6 | 1 |
| 28 | 2 | 0, 1, 2, and 4 | 1 |
| 29 | 2 | 0, 1, 4, and 5 | 1 |
| 30 | 3 | 0 | 1 |
| 31 | 3 | 1 | 1 |
| 32 | 3 | 2 | 1 |
| 33 | 3 | 3 | 1 |
| 34 | 3 | 4 | 1 |
| 35 | 3 | 5 | 1 |
| 36 | 3 | 6 | 1 |
| 37 | 3 | 7 | 1 |
| 38 | 3 | 8 | 1 |
| 39 | 3 | 9 | 1 |
| 40 | 3 | 10 | 1 |
| 41 | 3 | 11 | 1 |
| 42 | 3 | 0 and 1 | 1 |
| 43 | 3 | 2 and 3 | 1 |
| 44 | 3 | 4 and 5 | 1 |
| 45 | 3 | 6 and 7 | 1 |
| 46 | 3 | 8 and 9 | 1 |
| 47 | 3 | 10 and 11 | 1 |
| 48 | 3 | 0 to 2 | 1 |
| 49 | 3 | 4 to 6 | 1 |
| 50 | 3 | 8 to 10 | 1 |
| 51 | 3 | 0 to 3 | 1 |
| 52 | 3 | 4 to 7 | 1 |
| 53 | 3 | 8 to 11 | 1 |
| 54 | 3 | 0 | 2 |
| 55 | 3 | 1 | 2 |
| 56 | 3 | 2 | 2 |
| 57 | 3 | 3 | 2 |
| 58 | 3 | 4 | 2 |
| 59 | 3 | 5 | 2 |
| 60 | 3 | 6 | 2 |
| 61 | 3 | 7 | 2 |
| 62 | 3 | 8 | 2 |
| 63 | 3 | 9 | 2 |
| 64 | 3 | 10 | 2 |
| 65 | 3 | 11 | 2 |
| 66 | 3 | 12 | 2 |
| 67 | 3 | 13 | 2 |
| 68 | 3 | 14 | 2 |
| 69 | 3 | 15 | 2 |
| 70 | 3 | 16 | 2 |
| 71 | 3 | 17 | 2 |
| 72 | 3 | 18 | 2 |
| 73 | 3 | 19 | 2 |
| 74 | 3 | 20 | 2 |
| 75 | 3 | 21 | 2 |
| 76 | 3 | 22 | 2 |
| 77 | 3 | 23 | 2 |
| 78 | 3 | 0 and 1 | 2 |
| 79 | 3 | 2 and 3 | 2 |
| 80 | 3 | 4 and 5 | 2 |
| 81 | 3 | 6 and 7 | 2 |
| 82 | 3 | 8 and 9 | 2 |
| 83 | 3 | 10 and 11 | 2 |
| 84 | 3 | 12 and 13 | 2 |
| 85 | 3 | 14 and 15 | 2 |
| 86 | 3 | 16 and 17 | 2 |
| 87 | 3 | 18 and 19 | 2 |
| 88 | 3 | 20 and 21 | 2 |
| 89 | 3 | 22 and 23 | 2 |
| 90 | 3 | 0 to 2 | 2 |
| 91 | 3 | 4 to 6 | 2 |
| 92 | 3 | 8 to 10 | 2 |
| 93 | 3 | 0 to 3 | 2 |
| 94 | 3 | 4 to 7 | 2 |
| 95 | 3 | 8 to 11 | 2 |
| 96 | 1 | 0 | 2 |
| 97 | 1 | 1 | 2 |
| 98 | 1 | 2 | 2 |
| 99 | 1 | 3 | 2 |
| 100 | 1 | 12 | 2 |
| 101 | 1 | 13 | 2 |
| 102 | 1 | 14 | 2 |
| 103 | 1 | 15 | 2 |
| 104 | 1 | 0 and 1 | 2 |
| 105 | 1 | 2 and 3 | 2 |
| 106 | 1 | 12 and 13 | 2 |
| 107 | 1 | 14 and 15 | 2 |
| 108 | 1 | 0 to 2 | 2 |
| 109 | 1 | 12 to 14 | 2 |
| 110 | 1 | 0 to 3 | 2 |
| 111 | 1 | 12 to 15 | 2 |
| 112 | 2 | 0 and 1 | 2 |
| 113 | 2 | 2 and 3 | 2 |
| 114 | 2 | 12 and 13 | 2 |
| 115 | 2 | 14 and 15 | 2 |
| 116 | 2 | 4 and 5 | 2 |
| 117 | 2 | 6 and 7 | 2 |
| 118 | 2 | 16 and 17 | 2 |
| 119 | 2 | 18 and 19 | 2 |
| 120 | 2 | 0 to 2 | 2 |
| 121 | 2 | 4 to 6 | 2 |
| 122 | 2 | 0 to 3 | 2 |
| 123 | 2 | 4 to 7 | 2 |
| 124 to 127 | Reserved | Reserved | Reserved |

For Table 8, the first DMRS indication information may use seven bits for indication.

In some embodiments, in a case in which double codewords are enabled, when a type of the target DMRS is the second configuration type, and the maximum symbol length of the target DMRS is 2, the DMRS information of the target DMRS may be determined based on the first DMRS indication information. The DMRS information may include the first DMRS information. In this embodiment of this application, the DMRS information may be determined based on a DMRS indication table (that is, Table 9).

TABLE 9

| | Quantity | Port | Quantity |
|---|---|---|---|
| Serial | of target | infor- | of front- |
| number | CDM groups | mation | load symbols |
| 0 | 2 | 0, 1, 2, 4, and 5 | 1 |
| 1 | 2 | 0, 1, 2, 4, 5, and 6 | 1 |
| 2 | 2 | 0, 1, 2, 3, 4, 5, and 6 | 1 |
| 3 | 2 | 0, 1, 2, 3, 4, 5, 6, and 7 | 1 |
| 4 | 1 | 0, 1, 2, 3, and 12 | 2 |
| 5 | 1 | 0, 1, 2, 3, 12, and 13 | 2 |
| 6 | 1 | 0, 1, 2, 3, 12, 13, and 14 | 2 |
| 7 | 1 | 0, 1, 2, 3, 12, 13, 14, and 15 | 2 |
| 8 | 2 | 0, 1, 2, 3, and 12 | 2 |
| 9 | 2 | 4, 5, 6, 7, and 16 | 2 |
| 10 | 2 | 0, 1, 2, 3, 12, and 13 | 2 |
| 11 | 2 | 4, 5, 6, 7, 16, and 17 | 2 |
| 12 | 2 | 0, 1, 2, 3, 12, 13, and 14 | 2 |
| 13 | 2 | 4, 5, 6, 7, 16, 17, and 18 | 2 |
| 14 | 2 | 0, 1, 2, 3, 12, 13, 14, and 15 | 2 |
| 15 | 2 | 4, 5, 6, 7, 16, 17, 18, and 19 | 2 |

For Table 9, the first DMRS indication information may use four bits for indication.

In some embodiments, the port information includes any one of the following:
N ports in one CDM group, where N is a positive integer less than or equal to 8;
M ports in one CDM group and M ports in another CDM group, where M is a positive integer less than or equal to 4;
one port in one CDM group and two ports in another CDM group;
one port in one CDM group and three ports in another CDM group;
two ports in one CDM group and three ports in another CDM group; and
three ports in one CDM group and four ports in another CDM group.

In this embodiment of this application, in a case in which a single codeword is enabled, the DMRS information indicated by the first DMRS indication information includes the following cases:
Case 1: one port, for example, one port in one CDM group is indicated;
Case 2: two ports, for example, two ports in one CDM group are indicated, or one port in each of two CDM groups is indicated respectively;
Case 3: three ports, for example, three ports in one CDM group are indicated, one port in one of two CDM groups and two ports in the other of the two CDM groups are indicated respectively, or two ports in one of two CDM groups and one port in the other of the two CDM groups are indicated respectively; and
Case 4: four ports, for example, four ports in one CDM group are indicated, two ports in each of two CDM groups are indicated respectively, one port in one of two CDM groups and three ports in the other of the two CDM groups are indicated respectively, or three ports in one of two CDM groups and one port in the other of the two CDM groups are indicated respectively.

In this embodiment of this application, in a case in which double codewords are enabled, the DMRS information indicated by the first DMRS indication information includes the following cases:
Case 5: five ports, for example, five ports in one CDM group are indicated, or three ports in one of two CDM groups and two ports in the other of the two CDM groups are indicated respectively;
Case 6: six ports, for example, six ports in one CDM group are indicated, or three ports in one of two CDM groups and three ports in the other of the two CDM groups are indicated respectively;
Case 7: seven ports, for example, seven ports in one CDM group are indicated, or four ports in one of two CDM groups and three ports in the other of the two CDM groups are indicated respectively; and
Case 8: eight ports, for example, eight ports in one CDM group are indicated, or four ports in one of two CDM groups and four ports in the other of the two CDM groups are indicated respectively.

It should be noted that an indication form in which the first DMRS indication information indicates the port information includes but is not limited to the indication forms listed in this application, and is not further limited herein. For example, in a case in which the DMRS information indicated by the first DMRS indication information includes five ports, there may be another indication case, for example, one port in one of two CDM groups and four ports in the other of the two CDM groups are indicated respectively.

In some embodiments, before the terminal receives the first demodulation reference signal DMRS indication information sent by the network side device, the method further includes: the terminal reports first capability information to the network side device, where the first capability information indicates whether the terminal supports the network side device in indicating the DMRS information of the target DMRS by using the first DMRS indication information.

In this embodiment of this application, in a case in which the terminal reports the first capability information to a network side, the network side device may determine, based on the first capability information, whether the terminal supports the network side device in indicating the DMRS information of the target DMRS by using the first DMRS indication information. In a case in which the terminal supports the network side device in indicating the DMRS information of the target DMRS by using the first DMRS indication information, the network side device may indicate the DMRS information of the target DMRS by using the first DMRS indication information; or in a case in which the terminal does not support the network side device in indicating the DMRS information of the target DMRS by using the first DMRS indication information, the network side device may indicate DMRS information of a conventional DMRS in a conventional indication manner, for example, indicate the DMRS information by using third DMRS indication information.

In some embodiments, after the terminal reports the first capability information to the network side device, the method further includes:
the terminal receives first DMRS configuration information sent by the network side device, where the first DMRS configuration information indicates the terminal to determine the DMRS information of the target DMRS based on the first DMRS indication information.

In this embodiment of this application, the first DMRS configuration information may be RRC configuration signaling. The network side device may configure or indicate, by using the first DMRS configuration information, the terminal to determine the DMRS information of the target DMRS based on the first DMRS indication information. After receiving the first DMRS configuration information, the terminal may determine the DMRS information of the target DMRS based on the first DMRS indication information.

In some embodiments, after the terminal reports the first capability information to the network side device, the method further includes:
the terminal receives second DMRS indication information sent by the network side device, where the second DMRS indication information indicates the terminal whether to determine the DMRS information of the target DMRS based on the first DMRS indication information.

In this embodiment of this application, the second DMRS indication information may be understood as DCI or information carried through DCI. The network side device may switch an indication manner for the DMRS information by using the second DMRS indication information. For example, in a case in which the network side device indicates, by using the second DMRS indication information, the terminal to determine the DMRS information of the target DMRS based on the first DMRS indication information, the terminal may determine the DMRS information of the target DMRS by using the first DMRS indication information; or in a case in which the network side device indicates, by using the second DMRS indication information, the terminal to determine the DMRS information based on the third DMRS indication information, the terminal may determine the DMRS information by using the third DMRS indication information. The third DMRS indication information is used to determine DMRS information of a second DMRS. Ports, belonging to a same code division multiplexing CDM group, in the second DMRS are mapped based on a length-2 FD-OCC sequence.

In some embodiments, before the terminal receives the first demodulation reference signal DMRS indication information sent by the network side device, the method further includes: the terminal reports second capability information to the network side device, where the second capability information indicates whether the terminal supports reception of second DMRS indication information, and the second DMRS indication information indicates the terminal whether to determine the DMRS information of the target DMRS based on the first DMRS indication information.

In some embodiments, the second DMRS indication information is located in a target indicator field in downlink control information.

In this embodiment of this application, an indicator field (for example, 1-bit) may be added to the DCI to indicate the terminal to receive the first DMRS indication information or receive third DMRS indication information.

In some embodiments, that the terminal determines DMRS information of a target DMRS based on the first DMRS indication information includes:
the terminal determines the DMRS information of the target DMRS based on the first DMRS indication information and rank information in a case in which a data channel corresponding to the target DMRS is a Physical Uplink Shared Channel (PUSCH).

In this embodiment of this application, the rank information may be referred to as a rank value. When the data channel is the PUSCH, the DMRS information corresponding to the target DMRS may be jointly determined based on the rank value and the first DMRS indication information. The following describes the case of jointly determining the DMRS information corresponding to the target DMRS based on the rank value and the first DMRS indication information.

For example, when the type of the target DMRS is the first configuration type, a transform precoder is disabled, the maximum symbol length of the target DMRS is 1, and a rank is 1, the first DMRS indication information may use four bits for indication. When the type of the target DMRS is the first configuration type, a transform precoder is disabled, the maximum symbol length of the target DMRS is 1, and a rank is 2, the first DMRS indication information may use three bits for indication. When the type of the target DMRS is the first configuration type, a transform precoder is disabled, the maximum symbol length of the target DMRS is 1, and a rank is 3, the first DMRS indication information may use two bits for indication. When the type of the target DMRS is the first configuration type, a transform precoder is disabled, the maximum symbol length of the target DMRS is 1, and a rank is 4, the first DMRS indication information may use two bits for indication.

When the type of the target DMRS is the first configuration type, a transform precoder is disabled, the maximum symbol length of the target DMRS is 2, and a rank is 1, the first DMRS indication information may use five bits for indication. When the type of the target DMRS is the first configuration type, a transform precoder is disabled, the maximum symbol length of the target DMRS is 2, and a rank is 2, the first DMRS indication information may use five bits for indication. When the type of the target DMRS is the first configuration type, a transform precoder is disabled, the maximum symbol length of the target DMRS is 2, and a rank is 3, the first DMRS indication information may use three bits for indication. When the type of the target DMRS is the first configuration type, a transform precoder is disabled, the maximum symbol length of the target DMRS is 2, and a rank is 4, the first DMRS indication information may use three bits for indication.

When the type of the target DMRS is the second configuration type, a transform precoder is disabled, the maximum symbol length of the target DMRS is 1, and a rank is 1, the first DMRS indication information may use five bits for indication. When the type of the target DMRS is the second configuration type, a transform precoder is disabled, the maximum symbol length of the target DMRS is 1, and a rank is 2, the first DMRS indication information may use four bits for indication. When the type of the target DMRS is the second configuration type, a transform precoder is disabled, the maximum symbol length of the target DMRS is 1, and a rank is 3, the first DMRS indication information may use three bits for indication. When the type of the target DMRS is the second configuration type, a transform precoder is disabled, the maximum symbol length of the target DMRS is 1, and a rank is 4, the first DMRS indication information may use two bits for indication.

When the type of the target DMRS is the second configuration type, a transform precoder is disabled, the maximum symbol length of the target DMRS is 2, and a rank is 1, the first DMRS indication information may use six bits for indication. When the type of the target DMRS is the second configuration type, a transform precoder is disabled, the maximum symbol length of the target DMRS is 1, and a rank is 2, the first DMRS indication information may use six bits for indication. When the type of the target DMRS is the second configuration type, a transform precoder is disabled, the maximum symbol length of the target DMRS is 1, and a rank is 3, the first DMRS indication information may use four bits for indication. When the type of the target DMRS is the second configuration type, a transform precoder is disabled, the maximum symbol length of the target DMRS is 1, and a rank is 4, the first DMRS indication information may use three bits for indication.

Refer to FIG. 3. An embodiment of this application further provides a demodulation reference signal information indication method, including the following steps.

Step 301: A network side device sends first demodulation reference signal DMRS indication information to a terminal.

The first DMRS indication information is used to determine DMRS information of a target DMRS. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

In some embodiments, a port supported by the target DMRS includes a first port, a second port, a third port, a fourth port, a fifth port, a sixth port, a seventh port, and an eighth port.

The first port, the second port, the third port, and the fourth port belong to a first CDM group. The fifth port, the sixth port, the seventh port, and the eighth port belong to a second CDM group.

In some embodiments, in a case in which the target DMRS is a DMRS of a first configuration type, and a maximum symbol length of the target DMRS is 1, the DMRS information includes any one of the following:
the quantity of target CDM groups is 1, and the port information includes any one of the first port, the second port, the third port, and the fourth port;
the quantity of target CDM groups is 1, and the port information includes the first port and the second port, or includes the third port and the fourth port;
the quantity of target CDM groups is 1, and the port information includes the first port, the second port, and the third port;
the quantity of target CDM groups is 1, and the port information includes the first port, the second port, the third port, and the fourth port;
the quantity of target CDM groups is 2, and the port information includes any one of the first port, the second port, the third port, the fourth port, the fifth port, the sixth port, the seventh port, and the eighth port;
the quantity of target CDM groups is 2, and the port information includes the first port and the second port, includes the third port and the fourth port, includes the fifth port and the sixth port, includes the seventh port and the eighth port, or includes the first port and the fifth port;
the quantity of target CDM groups is 2, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port;
the quantity of target CDM groups is 2, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port; and
the quantity of target CDM groups is 2, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port.

In some embodiments, a port supported by the target DMRS includes a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, and a sixteenth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group.

In some embodiments, in a case in which the target DMRS is a DMRS of a first configuration type, and a maximum symbol length of the target DMRS is 2, the DMRS information includes any one of the following:
the quantity of target CDM groups is 1, the quantity of front-load symbols is 1, and the port information includes any one of the first port, the second port, the third port, and the fourth port;
the quantity of target CDM groups is 1, the quantity of front-load symbols is 1, and the port information includes the first port and the second port, or includes the third port and the fourth port;
the quantity of target CDM groups is 1, the quantity of front-load symbols is 1, and the port information includes the first port, the second port, and the third port;
the quantity of target CDM groups is 1, the quantity of front-load symbols is 1, and the port information includes the first port, the second port, the third port, and the fourth port;
the quantity of target CDM groups is 2, the quantity of front-load symbols is 1, and the port information includes any one of the first port, the second port, the third port, the fourth port, the fifth port, the sixth port, the seventh port, and the eighth port;
the quantity of target CDM groups is 2, the quantity of front-load symbols is 1, and the port information includes the first port and the second port, includes the third port and the fourth port, includes the fifth port and the sixth port, includes the seventh port and the eighth port, or includes the first port and the fifth port;
the quantity of target CDM groups is 2, the quantity of front-load symbols is 1, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port;
the quantity of target CDM groups is 2, the quantity of front-load symbols is 1, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port;
the quantity of target CDM groups is 2, the quantity of front-load symbols is 2, and the port information includes any one of the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, and the sixteenth port;
the quantity of target CDM groups is 2, the quantity of front-load symbols is 2, and the port information includes the first port and the second port, includes the third port and the fourth port, includes the fifth port and the sixth port, includes the seventh port and the eighth port, includes the ninth port and the tenth port, includes the eleventh port and the twelfth port, includes the thirteenth port and the fourteenth port, includes the fifteenth port and the sixteenth port, includes the first port and the ninth port, or includes the fifth port and the thirteenth port;
the quantity of target CDM groups is 2, the quantity of front-load symbols is 2, and the port information includes the first port, the second port, and the third port, includes the fifth port, the sixth port, and the seventh port, includes the first port, the second port, and the ninth port, or includes the fifth port, the sixth port, and the thirteenth port;
the quantity of target CDM groups is 2, the quantity of front-load symbols is 2, and the port information includes the first port, the second port, the third port, and the fourth port, includes the fifth port, the sixth port, the seventh port, and the eighth port, includes the first port, the second port, the ninth port, and the tenth port, or includes the fifth port, the sixth port, the thirteenth port, and the fourteenth port;
the quantity of target CDM groups is 2, the quantity of front-load symbols is 1, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port;
the quantity of target CDM groups is 1 or 2, the quantity of front-load symbols is 2, and the port information includes the first port, the second port, the third port, the fourth port, and the ninth port, includes the first port, the second port, the third port, the fourth port, the ninth port, and the tenth port, includes the first port, the second port, the third port, the fourth port, the ninth port, the tenth port, and the eleventh port, or includes the first port, the second port, the third port, the fourth port, the ninth port, the tenth port, the eleventh port, and the twelfth port; and
the quantity of target CDM groups is 2, the quantity of front-load symbols is 2, and the port information includes the fifth port, the sixth port, the seventh port, the eighth port, and the thirteenth port, includes the fifth port, the sixth port, the seventh port, the eighth port, the thirteenth port, and the fourteenth port, includes the fifth port, the sixth port, the seventh port, the eighth port, the thirteenth port, the fourteenth port, and the fifteenth port, or includes the fifth port, the sixth port, the seventh port, the eighth port, the thirteenth port, the fourteenth port, the fifteenth port, and the sixteenth port.

In some embodiments, a port supported by the target DMRS includes a first port, a second port, a third port, a fourth port, a fifth port, a sixth port, a seventh port, an eighth port, a ninth port, a tenth port, an eleventh port, and a twelfth port. The first port, the second port, the third port, and the fourth port belong to a first CDM group. The fifth port, the sixth port, the seventh port, and the eighth port belong to a second CDM group. The ninth port, the tenth port, the eleventh port, and the twelfth port belong to a third CDM group.

In some embodiments, in a case in which the target DMRS is a DMRS of a second configuration type, and a maximum symbol length of the target DMRS is 1, the DMRS information includes any one of the following:
the quantity of target CDM groups is 1, and the port information includes any one of the first port, the second port, the third port, and the fourth port;
the quantity of target CDM groups is 1, and the port information includes the first port and the second port, or includes the third port and the fourth port;
the quantity of target CDM groups is 1, and the port information includes the first port, the second port, and the third port;
the quantity of target CDM groups is 1, and the port information includes the first port, the second port, the third port, and the fourth port;
the quantity of target CDM groups is 2, and the port information includes any one of the first port, the second port, the third port, the fourth port, the fifth port, the sixth port, the seventh port, and the eighth port;
the quantity of target CDM groups is 2, and the port information includes the first port and the second port, includes the third port and the fourth port, includes the fifth port and the sixth port, includes the seventh port and the eighth port, or includes the first port and the fifth port;
the quantity of target CDM groups is 2, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port;
the quantity of target CDM groups is 2, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port;
the quantity of target CDM groups is 3, and the port information includes any one of the first port, the second port, the third port, the fourth port, the fifth port, the sixth port, the seventh port, the eighth port, the ninth port, the tenth port, the eleventh port, and the twelfth port;
the quantity of target CDM groups is 2, and the port information includes the first port and the second port, includes the third port and the fourth port, includes the fifth port and the sixth port, includes the seventh port and the eighth port, includes the ninth port and the tenth port, or includes the eleventh port and the twelfth port;
the quantity of target CDM groups is 3, and the port information includes the first port, the second port, and the third port, includes the fifth port, the sixth port, and the seventh port, or includes the ninth port, the tenth port, and the eleventh port;
the quantity of target CDM groups is 3, and the port information includes the first port, the second port, the third port, and the fourth port, includes the fifth port, the sixth port, the seventh port, and the eighth port, or includes the ninth port, the tenth port, the eleventh port, and the twelfth port; and
the quantity of target CDM groups is 2 or 3, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port.

In some embodiments, a port supported by the target DMRS includes a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, a sixteenth port, a seventeenth port, an eighteenth port, a nineteenth port, a twentieth port, a twenty-first port, a twenty-second port, a twenty-third port, and a twenty-fourth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group. The seventeenth port, the eighteenth port, the nineteenth port, the twentieth port, the twenty-first port, the twenty-second port, the twenty-third port, and the twenty-fourth port belong to a third CDM group.

In some embodiments, in a case in which the target DMRS is a DMRS of a second configuration type, and a maximum symbol length of the target DMRS is 2, the DMRS information includes any one of the following:
the quantity of target CDM groups is 1, the quantity of front-load symbols is 1, and the port information includes any one of the first port, the second port, the third port, and the fourth port;
the quantity of target CDM groups is 1, the quantity of front-load symbols is 1, and the port information includes the first port and the second port, or includes the third port and the fourth port;
the quantity of target CDM groups is 1, the quantity of front-load symbols is 1, and the port information includes the first port, the second port, and the third port;
the quantity of target CDM groups is 1, the quantity of front-load symbols is 1, and the port information includes the first port, the second port, the third port, and the fourth port;
the quantity of target CDM groups is 2, the quantity of front-load symbols is 1, and the port information includes any one of the first port, the second port, the third port, the fourth port, the fifth port, the sixth port, the seventh port, and the eighth port;
the quantity of target CDM groups is 2, the quantity of front-load symbols is 1, and the port information includes the first port and the second port, includes the third port and the fourth port, includes the fifth port and the sixth port, includes the seventh port and the eighth port, or includes the first port and the fifth port;
the quantity of target CDM groups is 2, the quantity of front-load symbols is 1, and the port information includes the first port, the second port, and the third port, includes the fifth port, the sixth port, and the seventh port, includes the first port, the second port, and the fifth port, includes the first port, the fifth port, and the sixth port, or includes the first port, the third port, and the fifth port;
the quantity of target CDM groups is 2, the quantity of front-load symbols is 1, and the port information includes the first port, the second port, the third port, and the fourth port, includes the fifth port, the sixth port, the seventh port, and the eighth port, includes the first port, the fifth port, the sixth port, and the seventh port, includes the first port, the second port, the third port, and the fifth port, includes the first port, the second port, the fifth port, and the sixth port, or includes the first port, the third port, the fifth port, and the seventh port;
the quantity of target CDM groups is 3, the quantity of front-load symbols is 1, and the port information includes any one of the first port, the second port, the third port, the fourth port, the fifth port, the sixth port, the seventh port, the eighth port, the ninth port, the tenth port, the eleventh port, and the twelfth port;
the quantity of target CDM groups is 3, the quantity of front-load symbols is 1, and the port information includes the first port and the second port, includes the third port and the fourth port, includes the fifth port and the sixth port, includes the seventh port and the eighth port, includes the ninth port and the tenth port, or includes the eleventh port and the twelfth port;
the quantity of target CDM groups is 3, the quantity of front-load symbols is 1, and the port information includes the first port, the second port, and the third port, includes the fifth port, the sixth port, and the seventh port, or includes the ninth port, the tenth port, and the eleventh port;
the quantity of target CDM groups is 3, the quantity of front-load symbols is 1, and the port information includes the first port, the second port, the third port, and the fourth port, includes the fifth port, the sixth port, the seventh port, and the eighth port, or includes the ninth port, the tenth port, the eleventh port, and the twelfth port;
the quantity of target CDM groups is 3, the quantity of front-load symbols is 2, and the port information includes any one of the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, the sixteenth port, the seventeenth port, the eighteenth port, the nineteenth port, the twentieth port, the twenty-first port, the twenty-second port, the twenty-third port, and the twenty-fourth port;
the quantity of target CDM groups is 3, the quantity of front-load symbols is 2, and the port information includes the first port and the second port, includes the third port and the fourth port, includes the fifth port and the sixth port, includes the seventh port and the eighth port, includes the ninth port and the tenth port, includes the eleventh port and the twelfth port, includes the thirteenth port and the fourteenth port, includes the fifteenth port and the sixteenth port, includes the seventeenth port and the eighteenth port, includes the nineteenth port and the twentieth port, includes the twenty-first port and the twenty-second port, or includes the twenty-third port and the twenty-fourth port;
the quantity of target CDM groups is 3, the quantity of front-load symbols is 2, and the port information includes the first port, the second port, and the third port, includes the fifth port, the sixth port, and the seventh port, or includes the ninth port, the tenth port, and the eleventh port;
the quantity of target CDM groups is 3, the quantity of front-load symbols is 2, and the port information includes the first port, the second port, the third port, and the fourth port, includes the fifth port, the sixth port, the seventh port, and the eighth port, or includes the ninth port, the tenth port, the eleventh port, and the twelfth port;
the quantity of target CDM groups is 1, the quantity of front-load symbols is 2, and the port information includes any one of the first port, the second port, the third port, the fourth port, the thirteenth port, the fourteenth port, the fifteenth port, and the sixteenth port;
the quantity of target CDM groups is 1, the quantity of front-load symbols is 2, and the port information includes the first port and the second port, includes the third port and the fourth port, includes the thirteenth port and the fourteenth port, or includes the fifteenth port and the sixteenth port;
the quantity of target CDM groups is 1, the quantity of front-load symbols is 2, and the port information includes the first port, the second port, and the third port, or includes the thirteenth port, the fourteenth port, and the fifteenth port;
the quantity of target CDM groups is 1, the quantity of front-load symbols is 2, and the port information includes the first port, the second port, the third port, and the fourth port, or includes the thirteenth port, the fourteenth port, the fifteenth port, and the sixteenth port;
the quantity of target CDM groups is 2, the quantity of front-load symbols is 2, and the port information includes the first port and the second port, includes the third port and the fourth port, includes the fifth port and the sixth port, includes the seventh port and the eighth port, includes the thirteenth port and the fourteenth port, includes the fifteenth port and the sixteenth port, includes the seventeenth port and the eighteenth port, or includes the nineteenth port and the twentieth port;
the quantity of target CDM groups is 2, the quantity of front-load symbols is 2, and the port information includes the first port, the second port, and the third port, or includes the fifth port, the sixth port, and the seventh port;
the quantity of target CDM groups is 2, the quantity of front-load symbols is 2, and the port information includes the first port, the second port, the third port, and the fourth port, or includes the fifth port, the sixth port, the seventh port, and the eighth port;
the quantity of target CDM groups is 2, the quantity of front-load symbols is 1, and the port information includes the first port, the second port, the third port, the fifth port, and the sixth port, includes the first port, the second port, the third port, the fifth port, the sixth port, and the seventh port, includes the first port, the second port, the third port, the fourth port, the fifth port, the sixth port, and the seventh port, or includes the first port, the second port, the third port, the fourth port, the fifth port, the sixth port, the seventh port, and the eighth port;
the quantity of target CDM groups is 1 or 2, the quantity of front-load symbols is 2, and the port information includes the first port, the second port, the third port, the fourth port, and the thirteenth port, includes the first port, the second port, the third port, the fourth port, the thirteenth port, and the fourteenth port, includes the first port, the second port, the third port, the fourth port, the thirteenth port, the fourteenth port, and the fifteenth port, or includes the first port, the second port, the third port, the fourth port, the thirteenth port, the fourteenth port, the fifteenth port, and the sixteenth port; and
the quantity of target CDM groups is 2, the quantity of front-load symbols is 2, and the port information includes the fifth port, the sixth port, the seventh port, the eighth port, and the seventeenth port, includes the fifth port, the sixth port, the seventh port, the eighth port, the seventeenth port, and the eighteenth port, includes the fifth port, the sixth port, the seventh port, the eighth port, the seventeenth port, the eighteenth port, and the nineteenth port, or includes the fifth port, the sixth port, the seventh port, the eighth port, the seventeenth port, the eighteenth port, the nineteenth port, and the twentieth port.

In some embodiments, the port information includes any one of the following:
N ports in one CDM group, where N is a positive integer less than or equal to 8;
M ports in one CDM group and M ports in another CDM group, where M is a positive integer less than or equal to 4;
one port in one CDM group and two ports in another CDM group;
one port in one CDM group and three ports in another CDM group;
two ports in one CDM group and three ports in another CDM group; and three ports in one CDM group and four ports in another CDM group.

In some embodiments, before the network side device sends the first demodulation reference signal DMRS indication information to the terminal, the method further includes: the network side device receives first capability information reported by the terminal, where the first capability information indicates whether the terminal supports the network side device in indicating the DMRS information of the target DMRS by using the first DMRS indication information.

In some embodiments, after the network side device receives the first capability information reported by the terminal, the method further includes:
the network side device sends first DMRS configuration information to the terminal, where the first DMRS configuration information indicates the terminal to determine the DMRS information of the target DMRS based on the first DMRS indication information.

In some embodiments, after the network side device receives the first capability information reported by the terminal, the method further includes:
the network side device sends second DMRS indication information to the terminal, where the second DMRS indication information indicates the terminal whether to determine the DMRS information of the target DMRS based on the first DMRS indication information.

In some embodiments, before the network side device sends the first demodulation reference signal DMRS indication information to the terminal, the method further includes: the network side device receives second capability information reported by the terminal, where the second capability information indicates whether the terminal supports reception of second DMRS indication information, and the second DMRS indication information indicates the terminal whether to determine the DMRS information of the target DMRS based on the first DMRS indication information.

In some embodiments, the second DMRS indication information is located in a target indicator field in downlink control information.

In some embodiments, the method further includes:
the network side device sends target indication information to the terminal, where the target indication information indicates rank information, such that the terminal determines the DMRS information of the target DMRS based on the first DMRS indication information and the rank information in a case in which a data channel corresponding to the target DMRS is a physical uplink shared channel.

According to this embodiment of this application, the DMRS information of the target DMRS is indicated by using the first DMRS indication information, and the ports, belonging to the same code division multiplexing CDM group, in the target DMRS are mapped based on the length-4 FD-OCC sequence. In this way, a DMRS of a data channel can support more ports. Therefore, according to this embodiment of this application, a transmission capacity of a communication system can be improved.

The demodulation reference signal information determining method provided in embodiments of this application may be performed by a demodulation reference signal information determining apparatus. In embodiments of this application, an example in which the demodulation reference signal information determining apparatus performs the demodulation reference signal information determining method is used to describe the demodulation reference signal information determining apparatus provided in embodiments of this application.

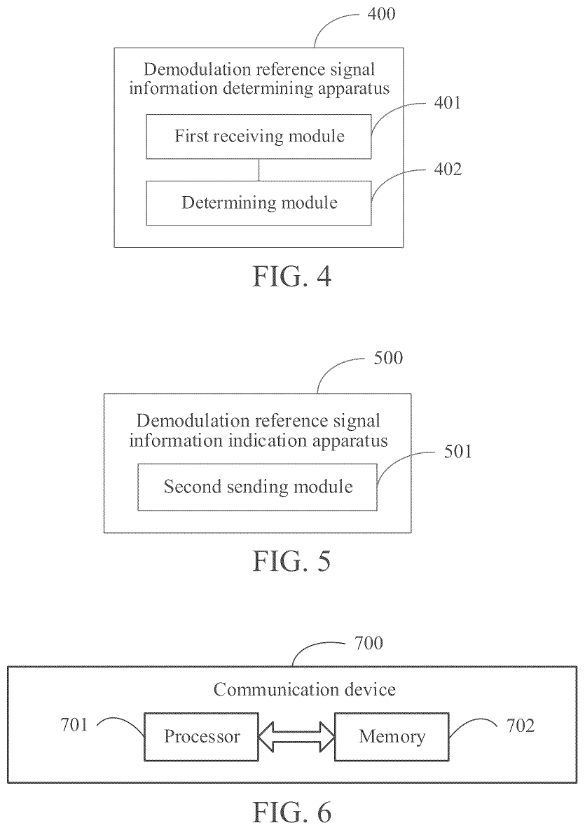

Refer to FIG. 4. An embodiment of this application further provides a demodulation reference signal information determining apparatus. The demodulation reference signal information determining apparatus 400 includes:
a first receiving module 401, configured to receive first demodulation reference signal DMRS indication information sent by a network side device; and
a determining module 402, configured to determine DMRS information of a target DMRS based on the first DMRS indication information.

Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

In some embodiments, a port supported by the target DMRS includes a first port, a second port, a third port, a fourth port, a fifth port, a sixth port, a seventh port, and an eighth port. The first port, the second port, the third port, and the fourth port belong to a first CDM group. The fifth port, the sixth port, the seventh port, and the eighth port belong to a second CDM group.

In some embodiments, in a case in which the target DMRS is a DMRS of a first configuration type, and a maximum symbol length of the target DMRS is 1, the DMRS information includes first DMRS information or second DMRS information.

In some embodiments, a port supported by the target DMRS includes a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, and a sixteenth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group.

In some embodiments, in a case in which the target DMRS is a DMRS of a first configuration type, and a maximum symbol length of the target DMRS is 2, the DMRS information includes third DMRS information or fourth DMRS information.

In some embodiments, a port supported by the target DMRS includes a first port, a second port, a third port, a fourth port, a fifth port, a sixth port, a seventh port, an eighth port, a ninth port, a tenth port, an eleventh port, and a twelfth port. The first port, the second port, the third port, and the fourth port belong to a first CDM group. The fifth port, the sixth port, the seventh port, and the eighth port belong to a second CDM group. The ninth port, the tenth port, the eleventh port, and the twelfth port belong to a third CDM group.

In some embodiments, in a case in which the target DMRS is a DMRS of a second configuration type, and a maximum symbol length of the target DMRS is 1, the DMRS information includes fifth DMRS information or sixth DMRS information.

In some embodiments, a port supported by the target DMRS includes a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, a sixteenth port, a seventeenth port, an eighteenth port, a nineteenth port, a twentieth port, a twenty-first port, a twenty-second port, a twenty-third port, and a twenty-fourth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group. The seventeenth port, the eighteenth port, the nineteenth port, the twentieth port, the twenty-first port, the twenty-second port, the twenty-third port, and the twenty-fourth port belong to a third CDM group.

In some embodiments, in a case in which the target DMRS is a DMRS of a second configuration type, and a maximum symbol length of the target DMRS is 2, the DMRS information includes seventh DMRS information or eighth DMRS information.

In some embodiments, the port information includes any one of the following:
N ports in one CDM group, where N is a positive integer less than or equal to 8;
M ports in one CDM group and M ports in another CDM group, where M is a positive integer less than or equal to 4;
one port in one CDM group and two ports in another CDM group;
one port in one CDM group and three ports in another CDM group;
two ports in one CDM group and three ports in another CDM group; and
three ports in one CDM group and four ports in another CDM group.

In some embodiments, the demodulation reference signal information determining apparatus 400 further includes:
a first sending module, configured to report first capability information to the network side device, where the first capability information indicates whether a terminal supports the network side device in indicating the DMRS information of the target DMRS by using the first DMRS indication information.

In some embodiments, the first receiving module 401 is further configured to receive first DMRS configuration information sent by the network side device, where the first DMRS configuration information indicates the terminal to determine the DMRS information of the target DMRS based on the first DMRS indication information.

In some embodiments, the first receiving module 401 is further configured to receive second DMRS indication information sent by the network side device, where the second DMRS indication information indicates the terminal whether to determine the DMRS information of the target DMRS based on the first DMRS indication information.

In some embodiments, the demodulation reference signal information determining apparatus 400 further includes:
a first sending module, configured to report second capability information to the network side device, where the second capability information indicates whether a terminal supports reception of second DMRS indication information, and the second DMRS indication information indicates the terminal whether to determine the DMRS information of the target DMRS based on the first DMRS indication information.

In some embodiments, the second DMRS indication information is located in a target indicator field in downlink control information.

In some embodiments, the determining module 402 is further configured to determine the DMRS information of the target DMRS based on the first DMRS indication information and rank information in a case in which a data channel corresponding to the target DMRS is a physical uplink shared channel.

The demodulation reference signal information indication method provided in embodiments of this application may be performed by a demodulation reference signal information indication apparatus. In embodiments of this application, an example in which the demodulation reference signal information indication apparatus performs the demodulation reference signal information indication method is used to describe the demodulation reference signal information indication apparatus provided in embodiments of this application.

Refer to FIG. 5. An embodiment of this application further provides a demodulation reference signal information indication apparatus. The demodulation reference signal information indication apparatus 500 includes:
a second sending module 501, configured to send first demodulation reference signal DMRS indication information to a terminal.

The first DMRS indication information is used to determine DMRS information of a target DMRS. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

In some embodiments, a port supported by the target DMRS includes a first port, a second port, a third port, a fourth port, a fifth port, a sixth port, a seventh port, and an eighth port. The first port, the second port, the third port, and the fourth port belong to a first CDM group. The fifth port, the sixth port, the seventh port, and the eighth port belong to a second CDM group.

In some embodiments, in a case in which the target DMRS is a DMRS of a first configuration type, and a maximum symbol length of the target DMRS is 1, the DMRS information includes first DMRS information or second DMRS information.

In some embodiments, a port supported by the target DMRS includes a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, and a sixteenth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group.

In some embodiments, in a case in which the target DMRS is a DMRS of a first configuration type, and a maximum symbol length of the target DMRS is 2, the DMRS information includes third DMRS information or fourth DMRS information.

In some embodiments, a port supported by the target DMRS includes a first port, a second port, a third port, a fourth port, a fifth port, a sixth port, a seventh port, an eighth port, a ninth port, a tenth port, an eleventh port, and a twelfth port. The first port, the second port, the third port, and the fourth port belong to a first CDM group. The fifth port, the sixth port, the seventh port, and the eighth port belong to a second CDM group. The ninth port, the tenth port, the eleventh port, and the twelfth port belong to a third CDM group.

In some embodiments, in a case in which the target DMRS is a DMRS of a second configuration type, and a maximum symbol length of the target DMRS is 1, the DMRS information includes fifth DMRS information or sixth DMRS information.

In some embodiments, a port supported by the target DMRS includes a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, a sixteenth port, a seventeenth port, an eighteenth port, a nineteenth port, a twentieth port, a twenty-first port, a twenty-second port, a twenty-third port, and a twenty-fourth port. The first port, the second port, the third port, the fourth port, the fifth port, the sixth port, the seventh port, and the eighth port belong to a first CDM group. The ninth port, the tenth port, the eleventh port, the twelfth port, the thirteenth port, the fourteenth port, the fifteenth port, and the sixteenth port belong to a second CDM group. The seventeenth port, the eighteenth port, the nineteenth port, the twentieth port, the twenty-first port, the twenty-second port, the twenty-third port, and the twenty-fourth port belong to a third CDM group.

In some embodiments, in a case in which the target DMRS is a DMRS of a second configuration type, and a maximum symbol length of the target DMRS is 2, the DMRS information includes seventh DMRS information or eighth DMRS information.

In some embodiments, the port information includes any one of the following:
N ports in one CDM group, where N is a positive integer less than or equal to 8;
M ports in one CDM group and M ports in another CDM group, where M is a positive integer less than or equal to 4;
one port in one CDM group and two ports in another CDM group;
one port in one CDM group and three ports in another CDM group;
two ports in one CDM group and three ports in another CDM group; and
three ports in one CDM group and four ports in another CDM group.

In some embodiments, the demodulation reference signal information indication apparatus 500 further includes:
a second receiving module, configured to receive first capability information reported by the terminal, where the first capability information indicates whether the terminal supports a network side device in indicating the DMRS information of the target DMRS by using the first DMRS indication information.

In some embodiments, the second sending module 501 is further configured to send first DMRS configuration information to the terminal, where the first DMRS configuration information indicates the terminal to determine the DMRS information of the target DMRS based on the first DMRS indication information.

In some embodiments, the second sending module 501 is further configured to send second DMRS indication information to the terminal, where the second DMRS indication information indicates the terminal whether to determine the DMRS information of the target DMRS based on the first DMRS indication information.

In some embodiments, the demodulation reference signal information indication apparatus 500 further includes:
a second receiving module, configured to receive second capability information reported by the terminal, where the second capability information indicates whether the terminal supports reception of second DMRS indication information, and the second DMRS indication information indicates the terminal whether to determine the DMRS information of the target DMRS based on the first DMRS indication information.

In some embodiments, the second DMRS indication information is located in a target indicator field in downlink control information.

In some embodiments, the second sending module 501 is further configured to send target indication information to the terminal, where the target indication information indicates rank information, such that the terminal determines the DMRS information of the target DMRS based on the first DMRS indication information and the rank information in a case in which a data channel corresponding to the target DMRS is a physical uplink shared channel.

The demodulation reference signal information determining apparatus and the demodulation reference signal information indication apparatus in embodiments of this application each may be an electronic device, for example, an electronic device with an operating system, or may be a component in an electronic device, for example, an integrated circuit or a chip. The electronic device may be a terminal or another device except a terminal. For example, the terminal may include but is not limited to the types of the terminal 11 listed above, and the another device may be a server, a Network Attached Storage (NAS), or the like, which are not specifically limited in embodiments of this application.

The demodulation reference signal information determining apparatus and the demodulation reference signal information indication apparatus provided in embodiments of this application can implement the processes implemented in the method embodiments in FIG. 2 and FIG. 3, with the same technical effects achieved. To avoid repetition, details are not described herein again.

For example, as shown in FIG. 6, an embodiment of this application further provides a communication device 600, including a processor 601 and a memory 602. The memory 602 stores a program or instructions runnable on the processor 601. For example, when the communication device 600 is a terminal, and the program or instructions are executed by the processor 601, the steps in the foregoing demodulation reference signal information determining method embodiment are implemented, with the same technical effects achieved. When the communication device 600 is a network side device, and the program or instructions are executed by the processor 601, the steps in the demodulation reference signal information indication method embodiment are implemented, with the same technical effects achieved. To avoid repetition, details are not described herein again.

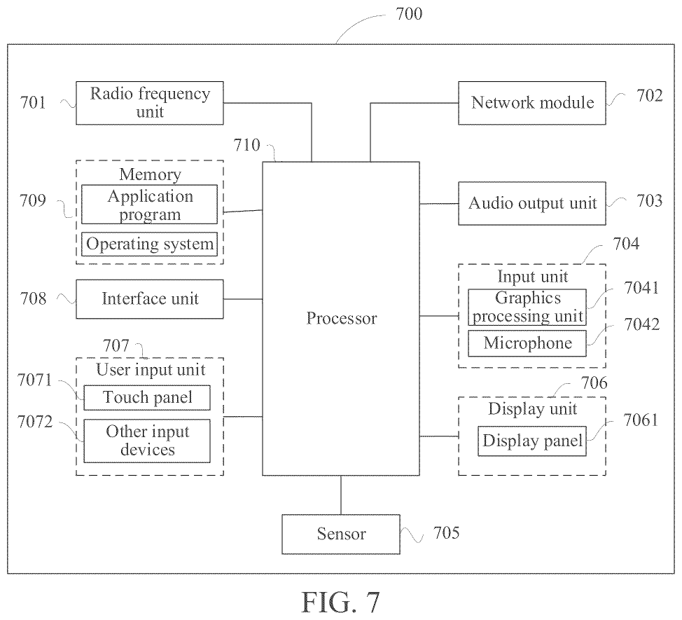

An embodiment of this application further provides a terminal, including a processor and a communication interface. The communication interface is configured to receive first demodulation reference signal DMRS indication information sent by a network side device. The processor is configured to determine DMRS information of a target DMRS based on the first DMRS indication information. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols. The terminal embodiment corresponds to the method embodiment for a terminal side, and all the implementation processes and implementations in the method embodiment are applicable to the terminal embodiment, with the same technical effects achieved. For example, FIG. 7 is a diagram of a hardware structure of the terminal for implementing an embodiment of this application.

The terminal 700 includes but is not limited to: at least some of a radio frequency unit 701, a network module 702, an audio output unit 703, an input unit 704, a sensor 705, a display unit 706, a user input unit 707, an interface unit 708, a memory 709, a processor 710, and the like.

It can be understood by a person skilled in the art that the terminal 700 may further include a power supply (for example, a battery) supplying power to the components. The power supply may be logically connected to the processor 710 through a power management system, so that functions such as charge and discharge management and power consumption management are implemented through the power management system. The structure of the terminal shown in FIG. 7 does not constitute any limitation on the terminal, and the terminal may include more or fewer components than shown in the diagram, combine some of the components, or have different arrangements of the components. Details are not described herein.

It should be understood that in this embodiment of this application, the input unit 704 may include a Graphics Processing Unit (GPU) 7041 and a microphone 7042. The graphics processing unit 7041 processes image data of a static picture or a video that is obtained by an image capture apparatus (for example, a camera) in a video capture mode or an image capture mode. The display unit 706 may include a display panel 7061. The display panel 7061 may be configured in a form of a liquid crystal display, an organic light-emitting diode, or the like. The user input unit 707 includes at least one of a touch panel 7071 and other input devices 7072. The touch panel 7071 is also referred to as a touchscreen. The touch panel 7071 may include two parts: a touch detection apparatus and a touch controller. The other input devices 7072 may include but are not limited to a physical keyboard, a function button (for example, a volume control button or a power on/off button), a trackball, a mouse, and a joystick. Details are not described herein.

In this embodiment of this application, the radio frequency unit 701 may transmit downlink data received from a network side device to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, and a duplexer.

The memory 709 may be configured to store a software program or instructions and various data. The memory 709 may mainly include a first storage area storing the program or instructions and a data storage area storing the data. The first storage area may store an operating system, an application program or instructions required for at least one function (for example, a sound play function and an image play function), and the like. In addition, the memory 709 may be a volatile memory or a non-volatile memory. In some alternative embodiments, the memory 709 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). The memory 709 in this embodiment of this application includes but is not limited to these and any other suitable types of memories.

The processor 710 may include one or more processing units. In some embodiments, the processor 710 integrates an application processor and a modem processor. The application processor mainly perform operations involving the operating system, a user interface, an application program, and the like. The modem processor, for example, a baseband processor, mainly processes a wireless communication signal. It may be understood that the modem processor may not be integrated into the processor 710.

The radio frequency unit 701 is configured to receive first demodulation reference signal DMRS indication information sent by the network side device.

The processor 710 is configured to determine DMRS information of a target DMRS based on the first DMRS indication information.

Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols.

An embodiment of this application further provides a network side device, including a processor and a communication interface. The communication interface is configured to send first demodulation reference signal DMRS indication information to a terminal. The first DMRS indication information is used to determine DMRS information of a target DMRS. Ports, belonging to a same code division multiplexing CDM group, in the target DMRS are mapped based on a length-4 FD-OCC sequence. The DMRS information includes at least one of the following: a quantity of target CDM groups, where the target CDM group is a CDM group, not occupied by data, in a CDM group corresponding to the target DMRS; port information of the target DMRS; and a quantity of front-load symbols. The network side device embodiment corresponds to the method embodiment for the network side device, and all the implementation processes and implementations in the method embodiment are applicable to the network side device embodiment, with the same technical effects achieved.

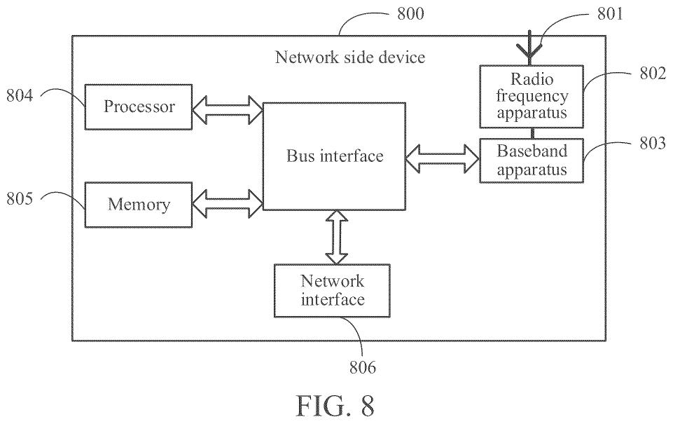

For example, an embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information by using the antenna 801, and sends the received information to the baseband apparatus 803 for processing. In a downlink direction, the baseband apparatus 803 processes to-be-sent information, and sends the information to the radio frequency apparatus 802; and the radio frequency apparatus 802 processes the received information and then sends the information out by using the antenna 801.

The method performed by the network side device in the foregoing embodiment may be implemented in the baseband apparatus 803, and the baseband apparatus 803 includes a baseband processor.

The baseband apparatus 803 may include, for example, at least one baseband board, where a plurality of chips are disposed on the baseband board. As shown in FIG. 8, one of the chips is, for example, the baseband processor, connected to the memory 805 through a bus interface, to invoke the program in the memory 805 to perform the operation of the network device shown in the foregoing method embodiment.

The network side device may further include a network interface 806. The interface is, for example, a common public radio interface (common public radio interface, CPRI).

For example, the network side device 800 in this embodiment of this application further includes instructions or a program stored in the memory 805 and runnable on the processor 804. The processor 804 invokes the instructions or program in the memory 805 to perform the method performed by the modules shown in FIG. 5, with the same technical effects achieved. To avoid repetition, details are not described herein again.

An embodiment of this application further provides a readable storage medium. The readable storage medium stores a program or instructions. When the program or instructions are executed by a processor, the processes in the foregoing demodulation reference signal information determining method or demodulation reference signal information indication method embodiment are implemented, with the same technical effect achieved. To avoid repetition, details are not described herein again.

The processor is the processor in the terminal described in the foregoing embodiment.

The readable storage medium includes a computer-readable storage medium, such as a computer ROM, a random access memory RAM, a magnetic disk, or an optical disc.

An embodiment of this application further provides a chip. The chip includes a processor and a communication interface. The communication interface is coupled to the processor.

The processor is configured to run a program or instructions to implement the processes of the foregoing demodulation reference signal information determining method or demodulation reference signal information indication method embodiment, with the same technical effects achieved. To avoid repetition, details are not described herein again.

It should be understood that the chip in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes of the foregoing demodulation reference signal information determining method or demodulation reference signal information indication method embodiment, with the same technical effects achieved. To avoid repetition, details are not described herein again.

An embodiment of this application further provides a communication system, including a terminal and a network side device. The terminal is configured to perform the processes in FIG. 2 and each method embodiment. The network side device is configured to perform the processes in FIG. 3 and each method embodiment. The same technical effects can be achieved. To avoid repetition, details are not described herein again.

It should be noted that in this specification, the terms “comprise” and “include” or any other variant thereof is intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. Furthermore, it should be noted that the scope of the methods and apparatuses in embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

According to the description of the foregoing implementations, a person skilled in the art can clearly understand that the method in the foregoing embodiments may be implemented by software in addition to a necessary universal hardware platform or by hardware only. In some embodiments, the technical solutions of this application entirely, or the part contributing to the conventional technology may be implemented in a form of a computer software product. The software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in embodiments of this application.

The foregoing describes embodiments of this application with reference to the accompanying drawings. However, this application is not limited to these embodiments. The embodiments are merely illustrative rather than restrictive. Inspired by this application, a person of ordinary skill in the art may develop many other manners without departing from the principle of this application and the protection scope of the claims, and all such manners fall within the protection scope of this application.

What is claimed is:

1. A demodulation reference signal information determining method, comprising:
receiving, by a terminal, first Demodulation Reference Signal (DMRS) indication information sent by a network side device; and
determining, by the terminal, DMRS information of a target DMRS based on the first DMRS indication information, wherein:
ports, belonging to a same Code Division Multiplexing (CDM group), in the target DMRS are mapped based on a length-4 Frequency Division-Orthogonal Cover Code (FD-OCC) sequence; and
the DMRS information comprises at least one of the following:
the quantity of target CDM groups, wherein the target CDM group is a CDM group, not occupied by data, in a CDM group corresponding to the target DMRS;
port information of the target DMRS; or
the quantity of front-load symbols.

2. The demodulation reference signal information determining method according to claim 1,
wherein:
a port supported by the target DMRS comprises: a first port, a second port, a third port, a fourth port, a fifth port, a sixth port, a seventh port, and an eighth port;
the first port, the second port, the third port, and the fourth port belong to a first CDM group; and
the fifth port, the sixth port, the seventh port, and the eighth port belong to a second CDM group.

3. The demodulation reference signal information determining method according to claim 2, wherein when the target DMRS is a DMRS of a first configuration type, and a maximum symbol length of the target DMRS is 1, the DMRS information comprises any one of the following:
the quantity of target CDM groups is 1, and the port information comprises any one of the first port, the second port, the third port, and the fourth port;
the quantity of target CDM groups is 1, and the port information comprises the first port and the second port, or comprises the third port and the fourth port;
the quantity of target CDM groups is 1, and the port information comprises the first port, the second port, and the third port;
the quantity of target CDM groups is 1, and the port information comprises the first port, the second port, the third port, and the fourth port;
the quantity of target CDM groups is 2, and the port information comprises any one of the first port, the second port, the third port, the fourth port, the fifth port, the sixth port, the seventh port, and the eighth port;
the quantity of target CDM groups is 2, and the port information comprises the first port and the second port, comprises the third port and the fourth port, comprises the fifth port and the sixth port, comprises the seventh port and the eighth port, or comprises the first port and the fifth port;
the quantity of target CDM groups is 2, and the port information comprises the first port, the second port, and the third port, comprises the fifth port, the sixth port, and the seventh port, comprises the first port, the second port, and the fifth port, comprises the first port, the fifth port, and the sixth port, or comprises the first port, the third port, and the fifth port;
the quantity of target CDM groups is 2, and the port information comprises the first port, the second port, the third port, and the fourth port, comprises the fifth port, the sixth port, the seventh port, and the eighth port, comprises the first port, the fifth port, the sixth port, and the seventh port, comprises the first port, the second port, the third port, and the fifth port, comprises the first port, the second port, the fifth port, and the sixth port, or comprises the first port, the third port, the fifth port, and the seventh port; or
the quantity of target CDM groups is 2, and the port information comprises the first port, the second port, the third port, the fifth port, and the sixth port, comprises the first port, the second port, the third port, the fifth port, the sixth port, and the seventh port, comprises the first port, the second port, the third port, the fourth port, the fifth port, the sixth port, and the seventh port, or comprises the first port, the second port, the third port, the fourth port, the fifth port, the sixth port, the seventh port, and the eighth port.

4. The demodulation reference signal information determining method according to claim 1,
wherein:
a port supported by the target DMRS comprises: a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, and a sixteenth port;
the first port, the second port, the third port, the fourth port, the fifth port, the sixth port, the seventh port, and the eighth port belong to a first CDM group; and
the ninth port, the tenth port, the eleventh port, the twelfth port, the thirteenth port, the fourteenth port, the fifteenth port, and the sixteenth port belong to a second CDM group.

5. The demodulation reference signal information determining method according to claim 4, wherein when the target DMRS is a DMRS of a first configuration type, and a maximum symbol length of the target DMRS is 2, the DMRS information comprises any one of the following:
the quantity of target CDM groups is 1, the quantity of front-load symbols is 1, and the port information comprises any one of the first port, the second port, the third port, and the fourth port;
the quantity of target CDM groups is 1, the quantity of front-load symbols is 1, and the port information comprises the first port and the second port, or comprises the third port and the fourth port;
the quantity of target CDM groups is 1, the quantity of front-load symbols is 1, and the port information comprises the first port, the second port, and the third port;
the quantity of target CDM groups is 1, the quantity of front-load symbols is 1, and the port information comprises the first port, the second port, the third port, and the fourth port;
the quantity of target CDM groups is 2, the quantity of front-load symbols is 1, and the port information comprises any one of the first port, the second port, the third port, the fourth port, the fifth port, the sixth port, the seventh port, and the eighth port;
the quantity of target CDM groups is 2, the quantity of front-load symbols is 1, and the port information comprises the first port and the second port, comprises the third port and the fourth port, comprises the fifth port and the sixth port, comprises the seventh port and the eighth port, or comprises the first port and the fifth port;
the quantity of target CDM groups is 2, the quantity of front-load symbols is 1, and the port information comprises the first port, the second port, and the third port, comprises the fifth port, the sixth port, and the seventh port, comprises the first port, the second port, and the fifth port, comprises the first port, the fifth port, and the sixth port, or comprises the first port, the third port, and the fifth port;
the quantity of target CDM groups is 2, the quantity of front-load symbols is 1, and the port information comprises the first port, the second port, the third port, and the fourth port, comprises the fifth port, the sixth port, the seventh port, and the eighth port, comprises the first port, the fifth port, the sixth port, and the seventh port, comprises the first port, the second port, the third port, and the fifth port, comprises the first port, the second port, the fifth port, and the sixth port, or comprises the first port, the third port, the fifth port, and the seventh port;
the quantity of target CDM groups is 2, the quantity of front-load symbols is 2, and the port information comprises any one of the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, and the sixteenth port;
the quantity of target CDM groups is 2, the quantity of front-load symbols is 2, and the port information comprises the first port and the second port, comprises the third port and the fourth port, comprises the fifth port and the sixth port, comprises the seventh port and the eighth port, comprises the ninth port and the tenth port, comprises the eleventh port and the twelfth port, comprises the thirteenth port and the fourteenth port, comprises the fifteenth port and the sixteenth port, comprises the first port and the ninth port, or comprises the fifth port and the thirteenth port;
the quantity of target CDM groups is 2, the quantity of front-load symbols is 2, and the port information comprises the first port, the second port, and the third port, comprises the fifth port, the sixth port, and the seventh port, comprises the first port, the second port, and the ninth port, or comprises the fifth port, the sixth port, and the thirteenth port;
the quantity of target CDM groups is 2, the quantity of front-load symbols is 2, and the port information comprises the first port, the second port, the third port, and the fourth port, comprises the fifth port, the sixth port, the seventh port, and the eighth port, comprises the first port, the second port, the ninth port, and the tenth port, or comprises the fifth port, the sixth port, the thirteenth port, and the fourteenth port;
the quantity of target CDM groups is 2, the quantity of front-load symbols is 1, and the port information comprises the first port, the second port, the third port, the fifth port, and the sixth port, comprises the first port, the second port, the third port, the fifth port, the sixth port, and the seventh port, comprises the first port, the second port, the third port, the fourth port, the fifth port, the sixth port, and the seventh port, or comprises the first port, the second port, the third port, the fourth port, the fifth port, the sixth port, the seventh port, and the eighth port;
the quantity of target CDM groups is 1 or 2, the quantity of front-load symbols is 2, and the port information comprises the first port, the second port, the third port, the fourth port, and the ninth port, comprises the first port, the second port, the third port, the fourth port, the ninth port, and the tenth port, comprises the first port, the second port, the third port, the fourth port, the ninth port, the tenth port, and the eleventh port, or comprises the first port, the second port, the third port, the fourth port, the ninth port, the tenth port, the eleventh port, and the twelfth port; or
the quantity of target CDM groups is 2, the quantity of front-load symbols is 2, and the port information comprises the fifth port, the sixth port, the seventh port, the eighth port, and the thirteenth port, comprises the fifth port, the sixth port, the seventh port, the eighth port, the thirteenth port, and the fourteenth port, comprises the fifth port, the sixth port, the seventh port, the eighth port, the thirteenth port, the fourteenth port, and the fifteenth port, or comprises the fifth port, the sixth port, the seventh port, the eighth port, the thirteenth port, the fourteenth port, the fifteenth port, and the sixteenth port.

6. The demodulation reference signal information determining method according to claim 1,
wherein:
a port supported by the target DMRS comprises: a first port, a second port, a third port, a fourth port, a fifth port, a sixth port, a seventh port, an eighth port, a ninth port, a tenth port, an eleventh port, and a twelfth port;
the first port, the second port, the third port, and the fourth port belong to a first CDM group;
the fifth port, the sixth port, the seventh port, and the eighth port belong to a second CDM group; and
the ninth port, the tenth port, the eleventh port, and the twelfth port belong to a third CDM group.

7. The demodulation reference signal information determining method according to claim 6, wherein when the target DMRS is a DMRS of a second configuration type, and a maximum symbol length of the target DMRS is 1, the DMRS information comprises any one of the following:
the quantity of target CDM groups is 1, and the port information comprises any one of the first port, the second port, the third port, and the fourth port;
the quantity of target CDM groups is 1, and the port information comprises the first port and the second port, or comprises the third port and the fourth port;
the quantity of target CDM groups is 1, and the port information comprises the first port, the second port, and the third port;
the quantity of target CDM groups is 1, and the port information comprises the first port, the second port, the third port, and the fourth port;
the quantity of target CDM groups is 2, and the port information comprises any one of the first port, the second port, the third port, the fourth port, the fifth port, the sixth port, the seventh port, and the eighth port;
the quantity of target CDM groups is 2, and the port information comprises the first port and the second port, comprises the third port and the fourth port, comprises the fifth port and the sixth port, comprises the seventh port and the eighth port, or comprises the first port and the fifth port;
the quantity of target CDM groups is 2, and the port information comprises the first port, the second port, and the third port, comprises the fifth port, the sixth port, and the seventh port, comprises the first port, the second port, and the fifth port, comprises the first port, the fifth port, and the sixth port, or comprises the first port, the third port, and the fifth port;
the quantity of target CDM groups is 2, and the port information comprises the first port, the second port, the third port, and the fourth port, comprises the fifth port, the sixth port, the seventh port, and the eighth port, comprises the first port, the fifth port, the sixth port, and the seventh port, comprises the first port, the second port, the third port, and the fifth port, comprises the first port, the second port, the fifth port, and the sixth port, or comprises the first port, the third port, the fifth port, and the seventh port;
the quantity of target CDM groups is 3, and the port information comprises any one of the first port, the second port, the third port, the fourth port, the fifth port, the sixth port, the seventh port, the eighth port, the ninth port, the tenth port, the eleventh port, and the twelfth port;
the quantity of target CDM groups is 2, and the port information comprises the first port and the second port, comprises the third port and the fourth port, comprises the fifth port and the sixth port, comprises the seventh port and the eighth port, comprises the ninth port and the tenth port, or comprises the eleventh port and the twelfth port;
the quantity of target CDM groups is 3, and the port information comprises the first port, the second port, and the third port, comprises the fifth port, the sixth port, and the seventh port, or comprises the ninth port, the tenth port, and the eleventh port;
the quantity of target CDM groups is 3, and the port information comprises the first port, the second port, the third port, and the fourth port, comprises the fifth port, the sixth port, the seventh port, and the eighth port, or comprises the ninth port, the tenth port, the eleventh port, and the twelfth port; or
the quantity of target CDM groups is 2 or 3, and the port information comprises the first port, the second port, the third port, the fifth port, and the sixth port, comprises the first port, the second port, the third port, the fifth port, the sixth port, and the seventh port, comprises the first port, the second port, the third port, the fourth port, the fifth port, the sixth port, and the seventh port, or comprises the first port, the second port, the third port, the fourth port, the fifth port, the sixth port, the seventh port, and the eighth port.

8. The demodulation reference signal information determining method according to claim 1,
wherein:
a port supported by the target DMRS comprises a first port, a second port, a third port, a fourth port, a fifth port, a sixth port, a seventh port, an eighth port, a ninth port, a tenth port, an eleventh port, a twelfth port, a thirteenth port, a fourteenth port, a fifteenth port, a sixteenth port, a seventeenth port, an eighteenth port, a nineteenth port, a twentieth port, a twenty-first port, a twenty-second port, a twenty-third port, and a twenty-fourth port;
the first port, the second port, the third port, the fourth port, the fifth port, the sixth port, the seventh port, and the eighth port belong to a first CDM group;
the ninth port, the tenth port, the eleventh port, the twelfth port, the thirteenth port, the fourteenth port, the fifteenth port, and the sixteenth port belong to a second CDM group; and
the seventeenth port, the eighteenth port, the nineteenth port, the twentieth port, the twenty-first port, the twenty-second port, the twenty-third port, and the twenty-fourth port belong to a third CDM group.

9. The demodulation reference signal information determining method according to claim 8, wherein when the target DMRS is a DMRS of a second configuration type, and a maximum symbol length of the target DMRS is 2, the DMRS information comprises any one of the following:
the quantity of target CDM groups is 1, the quantity of front-load symbols is 1, and the port information comprises any one of the first port, the second port, the third port, and the fourth port;
the quantity of target CDM groups is 1, the quantity of front-load symbols is 1, and the port information comprises the first port and the second port, or comprises the third port and the fourth port;
the quantity of target CDM groups is 1, the quantity of front-load symbols is 1, and the port information comprises the first port, the second port, and the third port;
the quantity of target CDM groups is 1, the quantity of front-load symbols is 1, and the port information comprises the first port, the second port, the third port, and the fourth port;
the quantity of target CDM groups is 2, the quantity of front-load symbols is 1, and the port information comprises any one of the first port, the second port, the third port, the fourth port, the fifth port, the sixth port, the seventh port, and the eighth port;
the quantity of target CDM groups is 2, the quantity of front-load symbols is 1, and the port information comprises the first port and the second port, comprises the third port and the fourth port, comprises the fifth port and the sixth port, comprises the seventh port and the eighth port, or comprises the first port and the fifth port;
the quantity of target CDM groups is 2, the quantity of front-load symbols is 1, and the port information comprises the first port, the second port, and the third port, comprises the fifth port, the sixth port, and the seventh port, comprises the first port, the second port, and the fifth port, comprises the first port, the fifth port, and the sixth port, or comprises the first port, the third port, and the fifth port;
the quantity of target CDM groups is 2, the quantity of front-load symbols is 1, and the port information comprises the first port, the second port, the third port, and the fourth port, comprises the fifth port, the sixth port, the seventh port, and the eighth port, comprises the first port, the fifth port, the sixth port, and the seventh port, comprises the first port, the second port, the third port, and the fifth port, comprises the first port, the second port, the fifth port, and the sixth port, or comprises the first port, the third port, the fifth port, and the seventh port;
the quantity of target CDM groups is 3, the quantity of front-load symbols is 1, and the port information comprises any one of the first port, the second port, the third port, the fourth port, the fifth port, the sixth port, the seventh port, the eighth port, the ninth port, the tenth port, the eleventh port, and the twelfth port;
the quantity of target CDM groups is 3, the quantity of front-load symbols is 1, and the port information comprises the first port and the second port, comprises the third port and the fourth port, comprises the fifth port and the sixth port, comprises the seventh port and the eighth port, comprises the ninth port and the tenth port, or comprises the eleventh port and the twelfth port;
the quantity of target CDM groups is 3, the quantity of front-load symbols is 1, and the port information comprises the first port, the second port, and the third port, comprises the fifth port, the sixth port, and the seventh port, or comprises the ninth port, the tenth port, and the eleventh port;
the quantity of target CDM groups is 3, the quantity of front-load symbols is 1, and the port information comprises the first port, the second port, the third port, and the fourth port, comprises the fifth port, the sixth port, the seventh port, and the eighth port, or comprises the ninth port, the tenth port, the eleventh port, and the twelfth port;
the quantity of target CDM groups is 3, the quantity of front-load symbols is 2, and the port information comprises any one of the first port, the second port, the third port, the fourth port, the fifth port, the sixth port, the seventh port, the eighth port, the ninth port, the tenth port, the eleventh port, the twelfth port, the thirteenth port, the fourteenth port, the fifteenth port, the sixteenth port, the seventeenth port, the eighteenth port, the nineteenth port, the twentieth port, the twenty-first port, the twenty-second port, the twenty-third port, and the twenty-fourth port;
the quantity of target CDM groups is 3, the quantity of front-load symbols is 2, and the port information comprises the first port and the second port, comprises the third port and the fourth port, comprises the fifth port and the sixth port, comprises the seventh port and the eighth port, comprises the ninth port and the tenth port, comprises the eleventh port and the twelfth port, comprises the thirteenth port and the fourteenth port, comprises the fifteenth port and the sixteenth port, comprises the seventeenth port and the eighteenth port, comprises the nineteenth port and the twentieth port, comprises the twenty-first port and the twenty-second port, or comprises the twenty-third port and the twenty-fourth port;
the quantity of target CDM groups is 3, the quantity of front-load symbols is 2, and the port information comprises the first port, the second port, and the third port, comprises the fifth port, the sixth port, and the seventh port, or comprises the ninth port, the tenth port, and the eleventh port;
the quantity of target CDM groups is 3, the quantity of front-load symbols is 2, and the port information comprises the first port, the second port, the third port, and the fourth port, comprises the fifth port, the sixth port, the seventh port, and the eighth port, or comprises the ninth port, the tenth port, the eleventh port, and the twelfth port;
the quantity of target CDM groups is 1, the quantity of front-load symbols is 2, and the port information comprises any one of the first port, the second port, the third port, the fourth port, the thirteenth port, the fourteenth port, the fifteenth port, and the sixteenth port;
the quantity of target CDM groups is 1, the quantity of front-load symbols is 2, and the port information comprises the first port and the second port, comprises the third port and the fourth port, comprises the thirteenth port and the fourteenth port, or comprises the fifteenth port and the sixteenth port;
the quantity of target CDM groups is 1, the quantity of front-load symbols is 2, and the port information comprises the first port, the second port, and the third port, or comprises the thirteenth port, the fourteenth port, and the fifteenth port;
the quantity of target CDM groups is 1, the quantity of front-load symbols is 2, and the port information comprises the first port, the second port, the third port, and the fourth port, or comprises the thirteenth port, the fourteenth port, the fifteenth port, and the sixteenth port;
the quantity of target CDM groups is 2, the quantity of front-load symbols is 2, and the port information comprises the first port and the second port, comprises the third port and the fourth port, comprises the fifth port and the sixth port, comprises the seventh port and the eighth port, comprises the thirteenth port and the fourteenth port, comprises the fifteenth port and the sixteenth port, comprises the seventeenth port and the eighteenth port, or comprises the nineteenth port and the twentieth port;
the quantity of target CDM groups is 2, the quantity of front-load symbols is 2, and the port information comprises the first port, the second port, and the third port, or comprises the fifth port, the sixth port, and the seventh port;
the quantity of target CDM groups is 2, the quantity of front-load symbols is 2, and the port information comprises the first port, the second port, the third port, and the fourth port, or comprises the fifth port, the sixth port, the seventh port, and the eighth port;
the quantity of target CDM groups is 2, the quantity of front-load symbols is 1, and the port information comprises the first port, the second port, the third port, the fifth port, and the sixth port, comprises the first port, the second port, the third port, the fifth port, the sixth port, and the seventh port, comprises the first port, the second port, the third port, the fourth port, the fifth port, the sixth port, and the seventh port, or comprises the first port, the second port, the third port, the fourth port, the fifth port, the sixth port, the seventh port, and the eighth port;
the quantity of target CDM groups is 1 or 2, the quantity of front-load symbols is 2, and the port information comprises the first port, the second port, the third port, the fourth port, and the thirteenth port, comprises the first port, the second port, the third port, the fourth port, the thirteenth port, and the fourteenth port, comprises the first port, the second port, the third port, the fourth port, the thirteenth port, the fourteenth port, and the fifteenth port, or comprises the first port, the second port, the third port, the fourth port, the thirteenth port, the fourteenth port, the fifteenth port, and the sixteenth port; or
the quantity of target CDM groups is 2, the quantity of front-load symbols is 2, and the port information comprises the fifth port, the sixth port, the seventh port, the eighth port, and the seventeenth port, comprises the fifth port, the sixth port, the seventh port, the eighth port, the seventeenth port, and the eighteenth port, comprises the fifth port, the sixth port, the seventh port, the eighth port, the seventeenth port, the eighteenth port, and the nineteenth port, or comprises the fifth port, the sixth port, the seventh port, the eighth port, the seventeenth port, the eighteenth port, the nineteenth port, and the twentieth port.

10. The demodulation reference signal information determining method according to claim 1, wherein the port information comprises any one of the following:
N ports in one CDM group, wherein N is a positive integer less than or equal to 8;
M ports in one CDM group and M ports in another CDM group, wherein M is a positive integer less than or equal to 4;
one port in one CDM group and two ports in another CDM group;
one port in one CDM group and three ports in another CDM group;
two ports in one CDM group and three ports in another CDM group; or
three ports in one CDM group and four ports in another CDM group.

11. The demodulation reference signal information determining method according to claim 1, wherein before receiving, by the terminal, the first DMRS indication information sent by the network side device, the method further comprises:
reporting, by the terminal, first capability information to the network side device, wherein the first capability information indicates whether the terminal supports the network side device in indicating the DMRS information of the target DMRS by using the first DMRS indication information.

12. The demodulation reference signal information determining method according to claim 11, wherein after reporting, by the terminal, the first capability information to the network side device, the method further comprises:
receiving, by the terminal, first DMRS configuration information sent by the network side device, wherein the first DMRS configuration information indicates the terminal to determine the DMRS information of the target DMRS based on the first DMRS indication information.

13. The demodulation reference signal information determining method according to claim 11, wherein after reporting, by the terminal, the first capability information to the network side device, the method further comprises:
receiving, by the terminal, second DMRS indication information sent by the network side device, wherein the second DMRS indication information indicates the terminal whether to determine the DMRS information of the target DMRS based on the first DMRS indication information.

14. The demodulation reference signal information determining method according to claim 1, wherein before receiving, by the terminal, the first DMRS indication information sent by the network side device, the method further comprises:
reporting, by the terminal, second capability information to the network side device, wherein the second capability information indicates whether the terminal supports reception of second DMRS indication information, and the second DMRS indication information indicates the terminal whether to determine the DMRS information of the target DMRS based on the first DMRS indication information.

15. The demodulation reference signal information determining method according to claim 14, wherein the second DMRS indication information is located in a target indicator field in downlink control information.

16. The demodulation reference signal information determining method according to claim 1, wherein determining, by the terminal, the DMRS information of the target DMRS based on the first DMRS indication information comprises:
determining, by the terminal, the DMRS information of the target DMRS based on the first DMRS indication information and rank information when a data channel corresponding to the target DMRS is a physical uplink shared channel.

17. The demodulation reference signal information determining method according to claim 12, wherein the first DMRS configuration information comprises RRC configuration signaling.

18. The demodulation reference signal information determining method according to claim 1, wherein the first DMRS indication information meets at least one of the following:
when the type of the target DMRS is a first configuration type, a transform precoder is disabled, and the maximum symbol length of the target DMRS is 1, the first DMRS indication information uses four bits for port indication;
when the type of the target DMRS is the first configuration type, the transform precoder is disabled, the maximum symbol length of the target DMRS is 2, and a rank is 1, the first DMRS indication information uses five bits for port indication;
when the type of the target DMRS is the first configuration type, the transform precoder is disabled, the maximum symbol length of the target DMRS is 2, and the rank is 2, the first DMRS indication information uses five bits for port indication;
when the type of the target DMRS is a second configuration type, the transform precoder is disabled, the maximum symbol length of the target DMRS is 1, and the rank is 1, the first DMRS indication information uses five bits for port indication;
when the type of the target DMRS is the second configuration type, the transform precoder is disabled, the maximum symbol length of the target DMRS is 2, and the rank is 1, the first DMRS indication information uses six bits for port indication; or
when the type of the target DMRS is the second configuration type, the transform precoder is disabled, the maximum symbol length of the target DMRS is 1, and the rank is 2, the first DMRS indication information uses six bits for port indication.

19. A terminal, comprising: a processor; and a memory having a computer program or an instruction stored thereon, wherein the computer program or the instruction, when executed by the processor, causes the processor to perform operations, comprising:
receiving first Demodulation Reference Signal (DMRS) indication information sent by a network side device; and
determining DMRS information of a target DMRS based on the first DMRS indication information,
wherein:
ports, belonging to a same Code Division Multiplexing (CDM group), in the target DMRS are mapped based on a length-4 Frequency Division-Orthogonal Cover Code (FD-OCC) sequence; and
the DMRS information comprises at least one of the following:
the quantity of target CDM groups, wherein the target CDM group is a CDM group, not occupied by data, in a CDM group corresponding to the target DMRS;
port information of the target DMRS; or
the quantity of front-load symbols.

20. A non-transitory computer-readable storage medium storing a computer program or an instruction that, when executed by a processor, causes the processor to perform operations, comprising:
receiving first Demodulation Reference Signal (DMRS) indication information sent by a network side device; and
determining DMRS information of a target DMRS based on the first DMRS indication information,
wherein:
ports, belonging to a same Code Division Multiplexing (CDM group), in the target DMRS are mapped based on a length-4 Frequency Division-Orthogonal Cover Code (FD-OCC) sequence; and
the DMRS information comprises at least one of the following:
the quantity of target CDM groups, wherein the target CDM group is a CDM group, not occupied by data, in a CDM group corresponding to the target DMRS;
port information of the target DMRS; or
the quantity of front-load symbols.
